(19) United States
(12) Patent Application Publication
(10) Pub. No.: US 2016/0083239 A1
(43) Pub. Date: Mar. 24, 2016

(54) A BEVERAGE DISPENSING SYSTEM AND A METHOD OF DISPENSING BEVERAGE

(71) Applicant: CARLSBERG BREWERIES A/S, Copenhagen V (DK)

(72) Inventors: Jan Norager Rasmussen, Olstykke (DK); Steen Vesborg, Gentofte (DK); Jonas Christiansen, Soborg (DK)

(73) Assignee: CARLSBERG BREWERIES A/S, Copenhagen V (DK)

(21) Appl. No.: 14/891,569

(22) PCT Filed: May 15, 2014
(86) PCT No.: PCT/EP2014/060007

§ 371 Date: Nov. 16, 2015

(30) Foreign Application Priority Data
May 16, 2013 (EP) 13168033.2

(51) Int. Cl. B67D 1/04; B67D 1/12; B67D 1/00

(52) U.S. Cl. CPC B67D 1/045; B67D 1/0406; B67D 1/0082; B67D 1/0443; B67D 1/1252

(57) ABSTRACT

The present invention relates to a beverage dispensing system (30). The beverage dispensing system comprises a beverage container (32) defining an internal volume including a beverage and an openable and closable dispensing device comprising a tapping line. The internal volume includes a canister (38) including a housing enclosing an adsorption material having an adsorbed a specific amount of propellant gas sufficient for replacing the beverage included in the internal volume. The internal volume also includes a bag (62) in fluid communication with the canister. The bag defines a first state in which the bag is folded and occupying less than 10% of the internal volume while the beverage contacting at least 25-50% of the housing of the canister. The bag also defines a second state in which the bag is unfolded and occupying at least 70% of the internal volume while the beverage contacting at least 25-50% of the housing of the canister.

The present invention relates to a beverage dispensing system and a method of dispensing beverage.

### INTRODUCTION

Beverage dispensing systems for carbonated beverages in which the carbonated beverage is stored in a so-called mini-keg or party-keg have been increasingly popular means of providing beverage at minor social events, such as private parties, family events and conferences, etc. Mini-kegs may also be used in professional beverage dispensing establishments, such as for smaller professional establishments, establishments lacking access to pressurization sources and establishments where highly pressurized containers may be unsuitable, such as in airplanes and other means of transportation. A mini-keg is a cheap and single-use beverage dispensing system for providing a larger amount of beverage than allowed in a can while not requiring the consumer to invest in a reusable beverage dispensing system. The mini-kegs typically have a volume ranging between the professional kegs and the single-use cans, such as 2-15 litres or 3-10 litres and in particular 5 litres. The mini-keg allows multiple beverage servings without loss of carbonisation or flavour even if some time is allowed to pass between the servings. It also gives the user the option of choosing the amount of beverage for each serving. State of the art mini-kegs include a tapping device for dispensing the beverage and a canister including a propellant gas such as CO₂ (carbon dioxide) for achieving a suitable dispensing pressure, compensate for pressure loss due to beverage dispensing and keeping the beverage in the mini-keg in a suitable drinking condition over an extended period of time such as several days or weeks, even if the mini-keg has been opened. In this way loss of carbonisation and flavour is avoided. Typically, a pressurized CO₂ atmosphere is kept inside the keg.

In the present context there is a need for a cheap and simple solution for pressurizing a beverage container. Some examples of self-pressurizing beverage containers are found in European patent publications EP 1 737 759 and EP 1 170 247. Both the above known technologies make use of commercially available CO₂ canisters containing pressurized CO₂ and a pressure regulation mechanism. The CO₂ canisters release CO₂ via the pressure regulator, which is used for pressurizing the beverage and the beverage container as the pressure is reduced due to the dispensing of the beverage as well as due to leakage during storage of the beverage container in-between servings. The canister will occupy space, which cannot be used for beverage. Therefore, the canister should preferably be small in relation to the volume of the beverage container. The canister must have a high pressure in order to be able to generate a suitable amount of CO₂ to pressurize a significantly large beverage container. The above-mentioned publications EP 1 737 759 and EP 1 170 247 suggest the use of a filler material such as activated carbon for reducing the pressure inside the canister.

In the present context, reference is made to the published international patent applications WO 2010/119056 and WO 2010/119054 which relate to a pressure maintaining beverage dispenser. Further prior art includes WO 99/47451 which relates to a device for dispensing a liquid. The device includes a first compartment for receiving the fluid to be dispensed and a second compartment for receiving a propellant. In WO 2009/126034 a container for holding and dispensing a pressurized beverage is disclosed. A pressure device is provided in the container for pressurizing the beverage. In WO 2011/152715 a beverage dispensing apparatus is disclosed including a pressure regulating chamber and a pressure sensing chamber. In WO2012/112035 a pressurizing device for a beverage container is disclosed. The pressurizing device includes an amount of dry ice which is allowed to sublimate.

The above-mentioned technologies have some drawbacks. The high pressure in the canisters of the above-mentioned technologies may constitute a safety hazard due to the risk of explosion, especially in case the canister is heated. The above technologies further include a mechanical pressure-reducing regulator, which may jam or break. The CO₂ canister and the pressure regulator must typically be made of metal to withstand the high pressures. Some mini-kegs may therefore be made entirely out of metal or a combination of metal and plastic. While many plastic materials may be disposed of in an environment-friendly manner by combustion, metal should be recycled in order to be considered an environment-friendly material. However, in many cases the above metal mini-kegs are not suitable for recycling since they differ from normal recyclable metal cans and kegs since they may contain a multitude of different plastic materials, which may not be separable and recyclable or disposed of in an environment-friendly manner. There is thus a risk that such mini-kegs will not be properly recycled.

The above safety hazard has been avoided in the beverage dispensing system described in WO2011/157786 in which a low pressurized adsorption material, e.g. activated carbon, is used in a canister and container entirely made of polymeric materials. The system thereby completely avoids high pressurized canisters and thus also the need of using a pressure regulator. The low pressure in the canister will also avoid excessive carbonization of the beverage and thus excessive foaming during dispensing of the beverage. As the beverage is being dispensed from the beverage dispensing system, it is continuously replaced by CO₂ which is being desorbed from the adsorption material. The expression ‘desorp’ is in the present context to be understood as the opposite to adsorb, i.e. the release of adsorbed gas from the adsorption material. The CO₂ in the head space of the beverage container thereby establishes equilibrium with the CO₂ adsorbed in the adsorption material, i.e. as the pressure in the beverage container reduces as the beverage is being dispensed, CO₂ is caused to be desorbed from the adsorption material. On the other hand, in case the pressure in the head space of the beverage container is increased, e.g. due to a sudden increase in temperature, the adsorption material will adsorb additional CO₂. In this way it can be ensured that the pressure in the beverage container is substantially maintained both in case of beverage dispensing and in case of a sudden temperature increase. Thus, both the risk of loss of driving pressure when only a small amount of beverage remains and the risk of container explosion in the sense that the pressure in the container may be relieved due to breakage or leakage in case of exposure to elevated temperature may be avoided.

As can be learned from the above publication WO2011/157786, the adsorption of CO₂ in the adsorption material as occurring during the filling of CO₂ into the canister is an exothermal process, i.e. a large amount of heat is generated. As it is explained in the above publication, the adsorption capability of the adsorption material will be lower with increasing temperature of the adsorption material, i.e. the adsorption occurs more readily at lower temperatures. Thus, the above publication suggests a two step filling process in order to allow the adsorption material to cool down in order to be able to adsorb further CO₂.

Conversely, the desorption of CO₂ from the adsorption material will occur more readily at higher temperature, i.e. the desorption at lower temperatures will occur less readily. Thus, at lower temperatures of the adsorption material, the equilibrium between the gas in the head space and the adsorbed gas in the adsorption material will be shifted so that a lower pressure in the head space will be established, assuming the adsorption material has a temperature not exceeding room temperature. Typically, in an operating state, the adsorption material has a temperature below room temperature corresponding to the drinking temperature of the beverage, i.e. a few degrees Celsius above zero. When a large amount of CO₂ has been desorbed from the adsorption material for replacing dispensed beverage, the temperature of the adsorption material will fall, in many cases below zero degrees Celsius such as −20° C. At such temperatures, the capability of the adsorption material to desorb CO₂ will be significantly reduced. Thus, there is a risk that the CO₂ in the adsorption material cannot replace the dispensed beverage, resulting in a pressure fall in the head space of the beverage container. When the pressure in the head space of the beverage container equals the ambient pressure, the beverage dispensing will stop. Thus, it is an object according to the present invention to ensure that the adsorption material is capable of replacing the entire amount of beverage included in the beverage container.

Carbonated beverages such as beer have a predetermined amount or concentration of CO₂ to give the beverage a suitable amount of fizzy bubbles and foaming. In relation to the above mentioned type of beverage dispensing systems, in which the CO₂ propellant gas is injected into or at least in direct contact with the beverage, the applicant has found out that under some circumstances there will be overcarbonisation of the beverage, i.e. that too much CO₂ is dissolved by the beverage. An excessive amount of dissolved CO₂ will yield an excessive amount of foam when the beverage is dispensed. The applicant has surprisingly found out that the problem of excessive foaming may be completely avoided in case the beverage and the CO₂ propellant gas are separated. Therefore, it is advantageous to separate the carbonated beverage and the propellant gas.

In WO03/050031 a container having an inner bag for receiving beverage is disclosed. There is an open communication between a gas supply channel and the inner space between the inner bag and the surrounding container.

WO 00/039444 discloses a beverage container comprising an outer container and included therein a flexible inner container in which the beverage is stored. The beverage is pressed out by introducing a pressure medium between the inner and the outer container.

DE 4231635 discloses a container for holding and transporting fluids. The container comprises a rigid outer container and a flexible bag located within the rigid outer container.

In WO2009/086830 a method of stretch blow moulding a beverage container is disclosed. The preform used for the stretch blow moulding has an inner layer of a first polymeric composition and an outer layer of a second polymeric composition. The body part of the preform is irradiated with radiation and blow moulding in order to achieve a double walled container.

WO2012/160198 discloses a method of improving the taste of a beverage. The beverage including dissolved and partially dissociated CO2 and a water insoluble or hydrophobic constituent. By subjecting the beverage to an external isostatic pressure exceeding the equilibrium pressure of the beverage, ultra fine bubbles will be formed, thereby improving the taste of the beverage will form. By separating the carbonated beverage and the propellant gas, such ultra fine bubbles improving the taste of the beverage may be formed.

### SUMMARY OF THE INVENTION

The above need and the above object together with numerous other needs and objects, which will be evident from the below detailed description, are according to a first aspect of the present invention obtained by a beverage dispensing system comprising:
a beverage container defining an internal volume, the internal volume including a beverage,
an openable and closable dispensing device comprising a tapping line having a beverage inlet located within the internal volume in fluid communication with the beverage and a beverage outlet located outside the beverage container,
a canister located within the internal volume, the canister including an adsorption material having an adsorbed specific amount of propellant gas sufficient for replacing the beverage included in the internal volume, the canister including a housing enclosing the adsorption material for preventing contact between the adsorption material and the beverage, and
a bag in fluid communication with the canister and located within the internal volume, the bag defining a first state in which the bag is folded and occupying less than 10% of the internal volume while the beverage contacting at least 25-50%, preferably 70%, more preferably 90%, of the housing of the canister, and, a second state in which the bag is unfolded and occupying at least 70% of the internal volume while the beverage contacting at least 25-50%, preferably 70%, more preferably 90%, of the housing of the canister.

The beverage container is typically made of moulded plastic material or metal and should be pressure proof. The beverage is typically a carbonated beverage such as beer or a soft drink, however, the present system may also be used for a non-carbonated beverage such as wine or fruit juice. The dispensing device preferably comprises a valve for opening and closing the tapping line. The tapping line extends between the internal volume of the beverage container and the outside of the beverage container. By operating the dispensing device from its normal closed state to the open state, beverage may flow from the internal volume via the dispensing line to a beverage glass located outside the beverage container.

The housing of the canister is preferably made of polymeric material, such as PET. Provided there exist a pressure difference between the inside and the outside of the canister, a pressure proof canister and bag should be used. One example of a situation in which the pressure may be larger inside the canister and bag than outside the bag and canister is when using the technology of WO2012/160198 according to which the pressure of the bag and canister should exceed the equilibrium pressure of the beverage by at least 1 barg [or bar(g)]. The adsorption material is typically activated carbon, however, other materials such as Zeolites are feasible. The propellant gas is typically CO₂, however, since the propellant gas should not contact the beverage, any other adsorbable gas would be feasible. The amount of adsorbed propellant gas should be sufficient so that all of the beverage may be replaced, and the remaining pressure in the inner volume is sufficient for completing the beverage dispensing, i.e. force the last amount of beverage to the outside via the tapping line. The bag is located within the internal volume and in contact with the beverage. The bag is initially folded. The bag should be made of a fluid tight, foldable but substantially non-elastic material having a low gas permeability. The bag is in contact with the beverage. The bag, the beverage and the canister should preferably fill the internal volume, however, a small head space may be allowed. The bag is filled with propellant gas and applies a dispensing pressure to the beverage. The dispensing pressure may range from 1 barg to 5 barg, typically 2-3 barg. As the beverage is being dispensed, the pressure in the internal volume, and thereby in the bag, is reduced. As the pressure falls in the bag, the pressure will fall in the canister as well, and propellant gas will be desorbed from the adsorption material. The adsorbed gas will flow into the bag which will increase in volume in order to compensate for the dispensed beverage volume.

Initially, in the first state, the volume of the bag should not exceed 10% of the internal volume in order to maximize the amount of beverage within the internal volume. When all of the beverage has been dispensed in the second state, the volume of the bag should exceed 70% of the internal volume in order to dispense all of the beverage in the internal volume. The volume of the bag substantially corresponds to the volume of the dispensed beverage. At all times, the beverage should at least contact 25-50% of the housing of the canister. In this way the beverage may transfer heat to the adsorption material.

The beverage typically comprises a major part water which is having a high thermal capacity and a high enthalpy of fusion. By contacting the beverage and the housing of the canister, the canister will be kept at a temperature not significantly below the temperature of the beverage. The adsorption material, which will be located in the vicinity of the housing of the canister, will due to the heat conduction from the housing be kept at a temperature not significantly below the temperature of the beverage. The beverage and the adsorption material is merely separated by the thin housing and not by any gas such that the adsorption material may be heated by the beverage via conductive heating. The heat conduction through beverage is significantly higher than the heat conduction through gas. As the beverage temperature is unlikely to be significantly below zero degrees Celsius (freezing point of water), the adsorption material will always be able to desorb a sufficiently large amount of propellant gas.

In the present embodiment, the beverage is located outside the bag. As the beverage is dispensed, the bag is continuously filled by propellant gas and unfolding. Initially, the beverage is preferably contacting a large surface of the housing of the canister. The bag should be made to unfold such that firstly, the beverage inlet of the tapping line remains unobstructed and secondly, such that the major part of the housing of the canister is contacting the beverage until substantially all of the beverage of the internal volume has been dispensed. The bag may thus unfold in a direction away from the canister.

The above need and the above object together with numerous other needs and objects, which will be evident from the below detailed description, are according to a second aspect of the present invention obtained by beverage dispensing system comprising:
a beverage container defining an internal volume,
a bag located within the internal volume, the bag including a beverage and a canister, the canister including an adsorption material having adsorbed a specific amount of propellant gas sufficient for replacing the beverage included within the bag, the canister being in fluid communication with the internal volume outside the bag, the canister including a housing enclosing the adsorption material for preventing contact between the adsorption material and the beverage, the bag defining a first state in which the bag is unfolded and occupying at least 70% of the internal volume while the beverage contacting at least 25-50%, preferably 70%, more preferably 90%, of the housing of the canister, and a second state in which the bag is folded and occupying less than 10% of the internal volume while the beverage contacting at least 25-50%, preferably 70%, more preferably 90%, of the housing of the canister, and
an openable and closable dispensing device comprising a tapping line having a beverage inlet located within the bag in fluid communication with the beverage and a beverage outlet located outside the beverage container.

In the present embodiment, which otherwise is very similar to the previous embodiment, the beverage is located within an unfolded bag. The propellant gas is located in the canister and outside the bag within the internal volume. Initially, the bag including beverage takes up a major part of the internal volume. As the beverage is being dispensed, the bag is folded by the force applied from the surrounding propellant gas released from the adsorption material as the beverage is flowing out of the bag. At all times, the beverage should at least contact 25-50% of the housing of the canister. According to a further embodiment, the bag is made of metal, metal coated polymeric material or polymeric material having a gas barrier. Whereas most polymeric material are not entirely fluid tight, most metals are. In order to avoid propellant gas migrating into the beverage through the bag, the bag may e.g. be made of aluminum coated plastic. Alternatively, the bag may be made of a gas tight polymeric material having a gas barrier.

According to a further embodiment, the canister at least partially encloses the tapping line. The amount of energy which may be transferred between the beverage and the adsorption material is largely determined by the area of contact between the beverage and the housing. In order to achieve an increased surface of contact, the canister may at least partially enclose the tapping line. This will have the additional advantage that the beverage which is about to leave the internal volume of the container is additionally cooled.

According to a further embodiment of the present invention, the housing of the canister comprises one or more grooves extending from a bottom surface of the housing to a top surface of the housing for allowing beverage to flow within the groove or grooves between the bottom surface and the top surface. The top surface of the housing is understood to be located adjacent the dispensing device whereas the bottom surface of the housing is understood to be located opposite the top surface within the internal volume. The amount of energy which may be transferred between the beverage and the adsorption material is determined by the temperature difference between the beverage and the adsorption material. Beverage flowing adjacent the housing of the canister will be warmer than the beverage already present in the groove since the beverage already present in the groove has been somewhat cooled down. The temperature difference between the incoming beverage and the beverage leaving the groove result in an improved heating of the adsorption material. Further, turbulent flow of beverage may additionally improve the thermal conductivity between the adsorption material and the beverage. In order to ensure that the beverage may flow adjacent the canister, the housing may include the groove or grooves.

According to a further embodiment of the present invention, the groove or grooves extending from the bottom surface of the housing to the top surface of the housing in a straight line or alternatively in a helical shape around the housing of the canister. A helical shape may be more difficult to manufacture, but will allow a longer distance of flow between the bottom surface and the top surface.

According to a further embodiment of the present invention, the housing extends from the dispensing device. The housing may be part of the dispensing device. In this way the installation of the dispensing device and the canister may be performed simultaneously and within a shorter period of time than installing both parts separately.

According to a further embodiment of the present invention, the bag is fastened onto the beverage container. By fastening the bag onto the container, the bag may be forced to fold/unfold away from the canister.

According to a further embodiment of the present invention, the internal volume comprises a plurality of canisters and optionally a plurality of bags. In this way the unfolding/folding of the bag may cause the canister to move within the internal volume. Each canister may also be made smaller. A plurality of bags may be advantageous since each bag must only fill out a smaller portion of the internal volume. In a special case, each canister is connected to a corresponding bag.

According to a further embodiment of the present invention, the container defines a cylindrical shape, when in the first state, the canisters are positioned at an imaginary central axis of the container whereas, when in the second state, the canisters are located at a distance from the imaginary central axis of the container. A single bag may be positioned at a central location having a plurality of canisters surrounding the bag. When the bag is being unfolded, the canisters are located adjacent the outer wall of the container, separated from each other and surrounded by beverage.

According to a further embodiment of the present invention, the container defines a cylindrical shape and each of the canisters defines a length exceeding the length of an imaginary central axis of the container. The opening of the container is limited due to the fact that a large opening is difficult to make pressure tight. The size of the canisters is typically limited to the area of the opening times the length of the container. In order to be able to use a larger canister, the canisters may be slightly longer than the container, and be slightly bent in order to fit within the container.

According to a further embodiment of the present invention, the canister defines a cylindrical surface and the bag is connected to the cylindrical surface. The bag must not be connected to the top or bottom of the canister, or via a pressure line. It is advantageous to use a large surface since the folding/unfolding may be more easily controlled. Thus, the large cylindrical surface may be advantageous to use for connecting the canister and the bag.

According to a further embodiment of the present invention, when in the first state, the bag is rolled around the cylindrical surface. In this way, both the folding/unfolding and the handling of the canister will be easier.

According to a further embodiment of the present invention, the beverage is a carbonated beverage defining an equilibrium pressure, the canister defining an internal gas pressure corresponding to the equilibrium pressure of the carbonated beverage, alternatively, the canister defining an internal gas pressure exceeding the equilibrium pressure of the carbonated beverage. In order to maintain the carbonisation of the carbonated beverage, the internal pressure in the canister and thereby in the bag should correspond to the equilibrium pressure of the carbonated beverage. By correspond is in the present context meant within +/−1 barg. Alternatively, the internal pressure in the canister and thereby in the bag may exceed the equilibrium pressure of the carbonated beverage in order to improve the taste of the beverage as described above with reference to WO2012/160198.

The above need and the above object together with numerous other needs and objects, which will be evident from the below detailed description, are according to a third aspect of the present invention obtained by a method of dispensing beverage, the method comprising providing a beverage dispensing system, the beverage dispensing system comprising:
a beverage container defining an internal volume, the internal volume including a beverage,
an openable and closable dispensing device comprising a tapping line having a beverage inlet located within the internal volume in fluid communication with the beverage and a beverage outlet located outside the beverage container,
a canister located within the internal volume, the canister including an adsorption material having adsorbed a specific amount of propellant gas sufficient for replacing the beverage included in the internal volume, the canister including a housing enclosing the adsorption material for preventing contact between the adsorption material and the beverage, and
a bag in fluid communication with the canister and located within the internal volume, the bag being folded and occupying less than 10% of the internal volume while the beverage contacting at least 25-50%, preferably 70%, more preferably 90%, of the housing of the canister, the method comprising performing the following step:
opening the dispensing device thereby causing the beverage to flow from the beverage inlet to the beverage outlet and the bag to receive propellant gas from the adsorption material while the bag is unfolding and the beverage contacting at least 25-50%, preferably 70%, more preferably 90%, of the housing of the canister until the bag occupying at least 70% of the internal volume.

The above method according to the third aspect may preferably be used together with the system according to the first aspect of the present invention.

The above need and the above object together with numerous other needs and objects, which will be evident from the below detailed description, are according to a fourth aspect of the present invention obtained by a method of dispensing beverage, the method comprising providing a beverage dispensing system, the beverage dispensing system comprising:
a beverage container defining an internal volume,
a bag located within the internal volume, the bag including a beverage and a canister, the canister including an adsorption material having adsorbed a specific amount of propellant gas sufficient for replacing the beverage included within the bag, the canister being in fluid communication with the internal volume outside the bag, the canister including a housing enclosing the adsorption material for preventing contact between the adsorption material and the beverage, the bag occupying at least 70% of the internal volume while the beverage contacting at least 25-50%, preferably 70%, more preferably 90%, of the housing of the canister, and
an openable and closable dispensing device comprising a tapping line having a beverage inlet located within the bag in fluid communication with the beverage and a beverage outlet located outside the beverage container, the method comprising performing the following step:
opening the dispensing device thereby causing the beverage to flow from the beverage inlet to the beverage outlet and the internal volume outside the bag to receive propellant gas from the adsorption material while the bag is being folded and the beverage contacting at least 25-50%, preferably 70%, more preferably 90%, of the housing of the canister until the bag occupying less than 10% of the internal volume.

The above method according to the fourth aspect of the present invention may preferably be used together with the system according to the second aspect of the present invention.

The above need and the above object together with numerous other needs and objects, which will be evident from the below detailed description, are according to a fifth aspect of the present invention obtained by a pressurization system for a cylindrical beverage container, the cylindrical beverage container defining a first diameter and having an internal volume including a beverage, the pressurization system comprising:
a cylindrical canister for being positioned within the internal volume, the canister including an adsorption material having an adsorbed specific amount of propellant gas sufficient for replacing the beverage included in the internal volume, the canister including a housing enclosing the adsorption material for preventing contact between the adsorption material and the beverage, and
a bag comprising an inner foil and an outer foil, the inner foil defining an inner upper edge, an opposite inner lower edge, a first side edge and an opposite second side edge welded to the first side edge, the inner foil defining an inner cylinder encircling the canister and defining a second diameter being substantially equal to the first diameter, the outer foil defining an outer upper edge being welded to the inner upper edge forming a common upper edge, an outer lower edge welded to the inner lower edge forming a common lower edge, a third side edge and an opposite fourth side edge welded to the third side edge, the outer foil defining an outer cylinder encircling the inner cylinder, the bag defining an enclosed space between the inner cylinder and the outer cylinder, the bag having a gas inlet providing fluid communication between the canister and the enclosed space, the enclosed space being separated into at least three internal spaces by welds extending partially between the common upper edge and the common lower edge, the bag defining a non-activated state in which the bag is folded about the canister, and an activated state in which the bag is unfolded and filled by the propellant gas.

According to a preferred embodiment of the fifth aspect, the enclosed space being separated into at least three internal spaces by joints, preferably welds, glues or stitching, extending partially between the common upper edge and the common lower edge.

The above mentioned pressurization system provides sufficient contact between the beverage and the canister to ensure that the temperature of the adsorption material does not fall below the critical temperature at which desorption of the carbon dioxide from the adsorption material stops, provides an unobstructed passage of beverage adjacent the canister and provides a very compact canister and bag combination before activation allowing the pressurization system to be stored and handled. When the beverage dispensing starts, the bag will unfold as the beverage is dispensed. The gas pressure generated in the canister will apply to the inner space of the bag and provide the pressure required for unfolding the bag inside the container and provide the necessary dispensing pressure. The passage adjacent the canister will allow passage of beverage independent of whether the container is orientated in a vertical or horizontal orientation and thus gives the user the choice of either positioning the beverage container in an upright position e.g. on a bar, or alternatively horizontally in e.g. a refrigerator.

The present bag is made from two opposing cylindrical foils which are welded together to form a cylindrical ring structure. The foils should be made of a material preventing carbon dioxide from migrating through the bag into the beverage. The spacing inbetween the foils may be inflated to form a doughnut or toroidal shape. The inner cylinder formed by the first foil, and consequently the outer cylinder as well, has a diameter substantially corresponding to the diameter of the beverage container and thus the inflated bag may easily fill the entire internal volume of the container. The joints of the bag extending between the common upper edge and the common lower edge will separate the enclosed space of the bag between the inner foil and the outer foil into at least three internal spaces.

The internal spaces still belong to the same enclosed space since the joints do not extend the entire distance between the common lower edge and the common upper edge, and thus roughly the same gas pressure will be present in all of the at least three internal spaces. However, the joints will prevent the bag from unfolding as a perfect toroid for the reason that the gas flow resistance between the internal spaces causes the internal space adjacent the gas inlet to inflate first. Additionally, the joints also prevent the bag from fully enclosing the canister since the joints will prevent inflation at the location of the weld and thus a constriction will apply at the location of the weld when the enclosed space of the bag is inflating. Typically, the joints will be welds, however, other joining means may be feasible such as glues or stitches.

Thus, the at least three internal spaces will each when inflated have an elliptic circumference extending at the widest location between the outer wall of the container and the canister while at the location of the joint the bag cannot inflate and thus at this location a cavity will exist which will allow passage of beverage. At the location of the weld, the bag and the canister will not meet up and there will thus establish an elongated cavity in which the beverage may pass.

According to a further embodiment, the gas inlet is located at the upper edge. Preferably, the gas inlet is located near the gas outlet of the canister such that the connection between the bag and the canister will be as short as possible.

According to a further embodiment, the first and second side edges are welded to the third and fourth side edges. In this way, one weld is provided which establishes one cavity in which beverage may flow adjacent the canister.

According to a further embodiment, the canister comprises a piercing device for ripping the bag when the pressure within the enclosed space increases substantially above the pressure within the internal volume of the beverage container, the piercing device preferably being covered by a flexible and piercable protection plate. In order to be able to depressurize the bag after the beverage has been dispensed, a piercing device may be located within the container. The piercing device, which may be a spike or nail, is preferably located adjacent the beverage outlet which will be the location of the last amount of beverage to be dispensed. Since the pressure in the beverage and the pressure in the bag is the same, the bag will not be pierced as long as the piercing device is enclosed by beverage. As the beverage container is empty or near empty, the pressure of the bag towards the piercing device will increase and the bag will be pierced. The gas inside the canister and in the bag may thus escape via the beverage outlet of the container.

According to a further embodiment, the bag has a first and a second cut out section in the foils at opposite sides of the gas inlet for allowing additional flexibility of the bag adjacent the gas inlet. In order for the bag to be flexible adjacent the pressure inlet, cutouts may be present. The cutouts allow the gas inlet to bend inwards or outwards.

According to a further embodiment, the bag has a cut out section at the common lower edge. In this way the bag may be made slightly longer than the beverage container in order to be capable of filling the complete container.

According to a further embodiment the bag comprises a lower part including the common lower edge and an upper part including the common upper edge, the lower part being foldable towards the upper part. In this way, a longer bag may be kept in a compact state before activation.

According to a further embodiment, the bag is made of a polymeric material, preferably plastics. Such materials may be e.g. a multilayer PE/EVOH/PE foil or a metalized PE foil.

According to a further embodiment, the bag when in the non activated state being surrounded by a cylindrical ribbon having a predetermined breaking point. In this way the bag is secured from unintentional unfolding before activation and protected from outside influence.

According to a further embodiment, the cylindrical ribbon is welded to the bag, or alternatively the cylindrical ribbon is completely enclosing the bag. In this way the bag is well protected during transport and handling.

The above need and the above object together with numerous other needs and objects, which will be evident from the below detailed description, are according to a sixth aspect of the present invention obtained by a method of manufacturing a pressurization system for a beverage container, the beverage container defining a first diameter and having an internal volume including a beverage, the method comprising the steps of:
providing a canister having a cylindrical shape for being positioned within the internal volume, the canister including an adsorption material having an adsorbed specific amount of propellant gas sufficient for replacing the beverage included in the internal volume, the canister including a housing enclosing the adsorption material for preventing contact between the adsorption material and the beverage,
providing an inner foil and an outer foil, the inner foil defining an inner upper edge, an opposite inner lower edge, a first side edge and an opposite second side edge, the outer foil defining an outer upper edge, an outer lower edge, a third side edge and an opposite fourth side edge,
welding the first side edge to the second side edge such that the inner foil defining an inner cylinder, the inner cylinder encircling the canister and defining a second diameter being substantially equal to the first diameter
welding the third side edge to the fourth side edge such that the outer foil defining an outer cylinder encircling the inner cylinder,
welding the outer upper edge to the inner upper edge forming a common upper edge and welding the outer lower edge to the inner lower edge forming a common lower edge such that the inner cylinder and the outer cylinder thereby defining a bag having a enclosed space between the inner cylinder and the outer cylinder,
separating the enclosed space into at least three internal spaces by welds extending partially between the common upper edge and the common lower edge
establishing a gas inlet in the bag for providing fluid communication between the canister and the enclosed space, and
folding the bag about the canister.

The above method according to the sixth aspect is preferably used for producing the pressurization system according to the fifth aspect.

According to a further embodiment, the folding step is performed using the following substep:
placing a mounting cylinder within the inner cylinder, and
rotating the mounting cylinder while holding the bag onto the mounting cylinder by applying low pressure to the mounting cylinder thereby folding the bag about the mounting cylinder,
replacing the mounting cylinder by the canister.

According to a further embodiment the folding step is performed using the following substep:
placing the canister within the inner cylinder,
surrounding the canister and the bag by four mounting rollers pressing against the bag, and
rotating the mounting rollers and the canister while holding the mounting rollers pressed against the bag.

The above embodiments constitute two alternative modes of folding the bag about the container in order to form a compact pressurization system.

According to a further embodiment the method further comprises the step of surrounding the bag by a cylindrical ribbon having a predetermined breaking point. The predetermined breaking point may be adapted to break when the bag is subjected to an elevated pressure, i.e. when the pressurization system has been activated.

### BRIEF DESCRIPTION OF THE DRAWINGS

FIG. 1 is a side view of a beverage dispensing system,

FIG. 2 is a perspective view of a bag-less beverage dispensing system,

FIG. 3 is a perspective view of a constant flow rate controller,

FIG. 4 is a side cut-out view of a constant flow rate controller,

FIG. 5 is a side cut-out view of a first embodiment of a flow control part,

FIG. 6 is a perspective view of a second embodiment of a flow control part,

FIG. 7 is a perspective view of a third embodiment of a flow control part,

FIG. 8 is a side cut-out view of a fourth embodiment of a flow control part,

FIG. 9 is a perspective view of the fourth embodiment of a flow control part,

FIG. 10 is a side view of a beverage dispensing system having a folded bag,

FIG. 11 is a side view of a beverage dispensing system having a central riser pipe,

FIG. 12 is a side view of a beverage dispensing system having straight line grooves,

FIG. 13 is a side view of a beverage dispensing system having helical grooves,

FIG. 14 is a side view of a beverage dispensing system having several canisters,

FIG. 15 is a side view of another beverage dispensing system having several canisters,

FIG. 16 is a side view of a beverage dispensing system having a central bag,

FIG. 17 is a side view of a beverage dispensing system having a side bag,

FIG. 18 is a side view of a beverage dispensing system having a rolled bag,

FIG. 19 is a side view of a beverage dispensing system having elongated canisters,

FIG. 20 is a side view of a beverage dispensing system having beverage filled bags,

FIG. 21 is a view of the pressurisation system in the non-activated state,

FIG. 22 is a view of the pressurisation system when activated,

FIG. 23 is a view of the pressurisation system when the bag is partly unfolded,

FIG. 24 is a view of the pressurisation system when the bag is fully unfolded,

FIG. 25 is a view of the pressurisation system when the bag is fully inflated,

FIG. 26 is a view of the pressurisation system when the beverage has been dispensed,

FIG. 27 is a view of the pressurisation system including bag and canister,

FIG. 28 is a view of the pressurisation system when the container is horizontal,

FIG. 29 is a view of the pressurisation system when the container is vertical,

FIG. 30 is a view of a first mounting setup for folding the bag,

FIG. 31 is a view of a second mounting setup for folding the bag,

FIG. 32 is a view of a piercing device for piercing the bag,

FIG. 33 is a view of a piercing member and a flexible member of the piercing device,

FIG. 34 is a view of the piercing of the bag by the piercing member

### DETAILED DESCRIPTION OF THE DRAWINGS

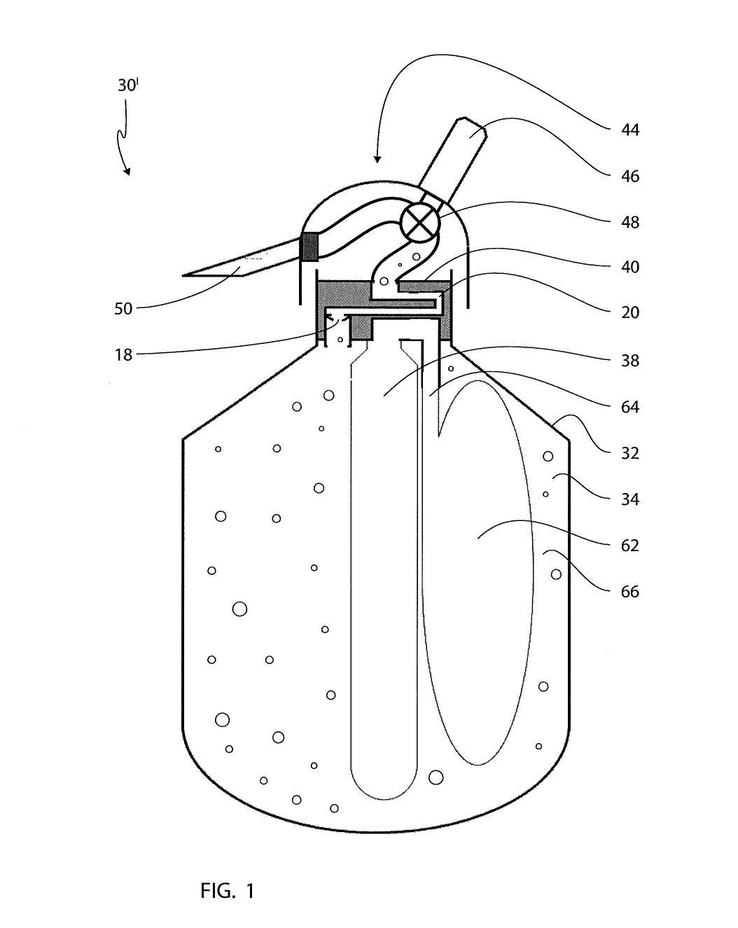

FIG. 1 shows a side view of a beverage dispensing system 30^{I}. The beverage dispensing system 30^{I} comprises a container 32 of rigid plastic material. The container 30^{I} defines an inner space 34. The inner space 34 comprises a canister 38 having an elongated cylindrical shape. The canister 38 is filled with propellant gas, such as CO₂, which has been adsorbed in an adsorption material, such as activated carbon. The canister 38 defines a driving pressure being a pressure above atmospheric pressure such as 2-3 barg. The canister 38 is typically made of substantially rigid plastic material. The canister 38 is connected to a foldable bag 62 fluid tight via a gas connection 64. The bag 62 should be substantially fluid tight. The remaining part of the inner space 34 outside the bag 62, the gas connection 64 and the canister 38 is filled with beverage 66, preferably carbonated beverage.

The container 32 is sealed by means of a lid 40 onto which both the canister 38 and the gas connection 64 is attached. The lid 40 further comprises a flow control part 18 and a flow control conduit 20 which as such are optional and may be replaced by a simple conduit. The flow control part 18 and the flow control conduit 20 contribute to reducing foaming during dispensing as will be further explained below. The lid 40 forms part of a dispensing device 44 which further comprise a valve 48 which is connected to the flow control conduit 20 for controlling the beverage dispensing. When the valve 44 is open, the beverage 66 may flow from the inner space 34 via the flow control part 18, flow control conduit 20 and valve 48 and be dispensed at a spout 50. When the valve 44 is closed, the beverage dispensing is prevented. The valve 48 is controlled by a handle 46.

The pressure inside the inner space 34 of the container 32 forces the beverage out through the flow control part 18, flow control conduit 20, valve 48 and spout 50 when the valve 40 is open. When the beverage is being dispensed, the pressure will fall inside the inner space 34. Some of the gas adsorbed in the adsorption material inside the canister 38 will consequently desorb and establish a new pressure equilibrium at a slightly lower pressure. The pressurized gas from the canister 38 will flow via the gas connection 64 into the bag 62 which will fold out. As the dispensing continues, more and more beverage will be replaced by gas from the adsorption material within the canister 38, and the dispensing pressure will be substantially maintained. The beverage 66 and the gas will be separated by the fluid tight bag 62, which will fold out and thereby increase in volume and provide a dispensing pressure for the beverage 66. The contact between the beverage 66 and the CO₂ propellant gas is thereby prevented. In this way the beverage 66 cannot be over-carbonized, and the risk of excessive foaming of the beverage during dispensing is reduced.

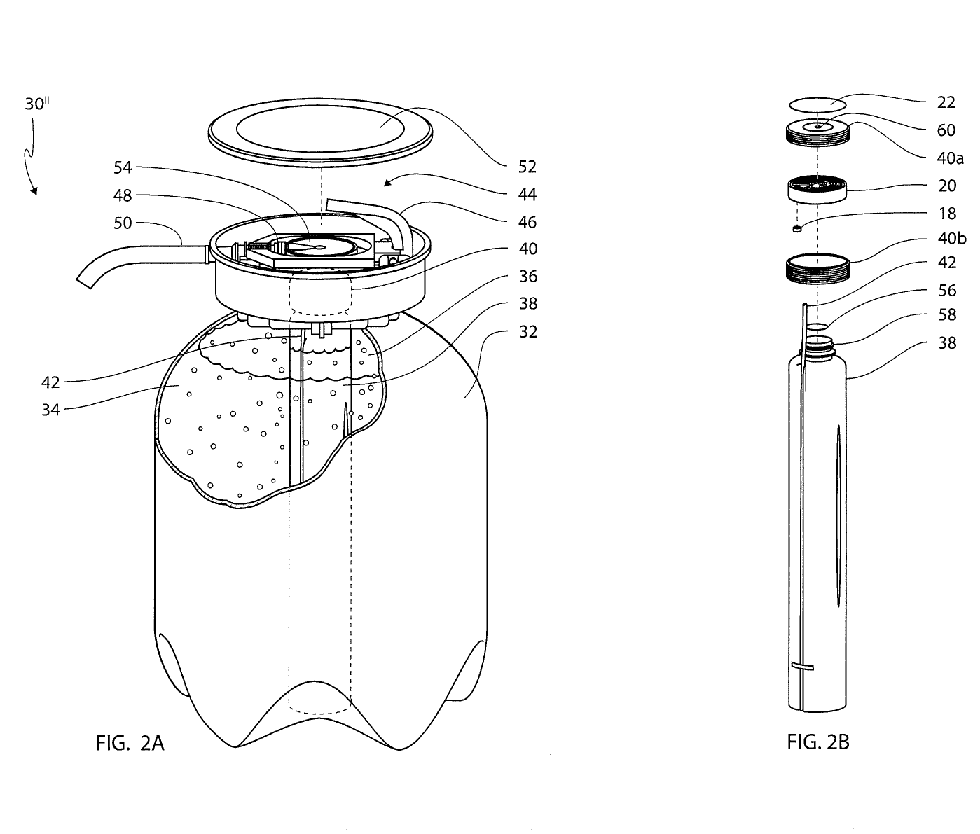

FIG. 2A shows a perspective view of a bag-less beverage dispensing system 30^{II}. The beverage dispensing system comprises a beverage container 32. The beverage container 32 defines an inner space 34 filled with carbonated beverage. A head space 36 of CO₂ gas is located above the inner space 34. The beverage container 32 further comprises a canister 38 filled with CO₂. The canister 38 preferably includes a filler material. The canister 38 is in gaseous communication with the head space 36 of the container 32, preferably via capillary tubes (not shown) in order to avoid leakage of beverage into the canister 38. When the complete inner space 34 beverage has been substituted by gas, the head space 36 will fill the complete beverage container 32. In order to reduce foaming, a bag may be used to separate the beverage and the CO₂ propellant gas.

The canister 38 is sealed off by a lid 40 which also seals off the beverage container 32. A riser pipe 42 extends from the inner space 34 via the lid 40 to a dispensing device 44. The dispensing device 44 comprises a dispensing handle 46 which is controlling a dispensing valve 48. By pulling the dispensing handle 46, the dispensing valve 48 is operated from the non-beverage dispensing position, i.e. the valve is shut, to the beverage dispensing position, i.e. the valve is open, allowing beverage to flow from the container 32 via the riser pipe 42, the lid 40 and the dispensing device 44 to the outside of the beverage dispensing system 30^{II}. Optionally, a spout 50 may be used for directing the beverage from the valve 48 into a beverage glass (not shown). Further, also optional, a cover 52 may be used to protect the dispensing device 30^{II} during transport. An activation mechanism 54 is used for activating beverage dispensing as described below.

FIG. 2B shows a perspective view of the canister 38. The canister 38 comprises the riser pipe 42 which interconnects the inner space of the container and the flow control conduit 20. The lid 40 comprises a lid top 40a and a lid bottom 40b. The canister 38 is sealed to the lid bottom 40b by a sealing 56. Gaseous communication is provided between the interior of the canister 38 and the head space 36 of the container 32 by a capillary channel 58 which allows gas but not liquid to pass. The canister 38 comprises filler (not shown) of activated carbon which is capable of adsorbing sufficient CO2 gas to substitute the complete inner space 34. The flow control conduit 20 is enclosed between the lid bottom 40b and the lid top 40a. The flow control part 18 is located between the riser pipe 42 and the flow control conduit 20. The lid top 40a has an aperture 60 which is covered by a rupturable membrane 22.

In order to enable beverage dispensing, the user typically activates the activation mechanism which causes the dispensing device to penetrate the rupturable membrane 22 and allow beverage to flow from the inner space of the container to the dispensing device via the riser pipe 42, the flow control part 18 and the flow control conduit 20.

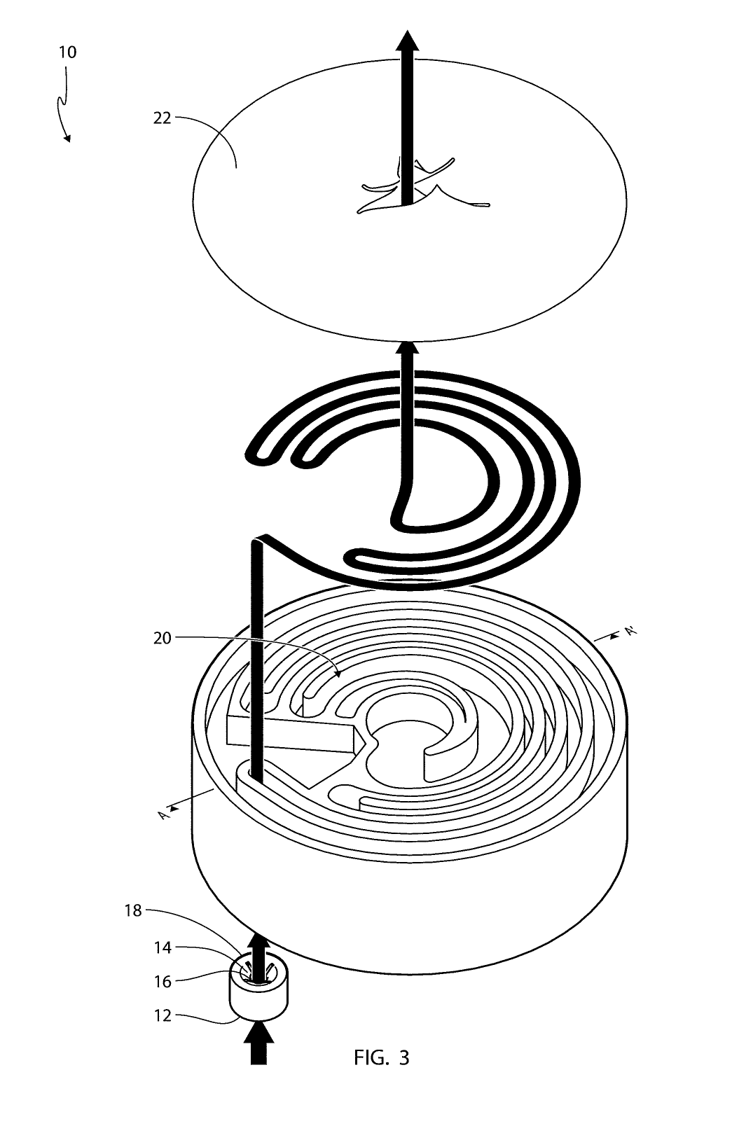

FIG. 3 shows a perspective view of a constant flow rate controller 10. The constant flow rate controller 10 defines an inlet 12, an outlet 14 and an orifice 16. The constant flow rate controller comprises a flow control part 18 which will be explained in more detail in connection with the next figures. The outlet 14 is connected to a laminar flow conduit 20. The laminar flow conduit 20 has a meandering shape. The laminar flow conduit 20 is sealed by a rupturable membrane 22. In order to enable beverage dispensing, the rupturable membrane 22 should be pierced in the center in order to allow passage from the inlet 12 to the outside via the laminar flow conduit 20.

The flow path through the constant flow rate controller 10 during dispensing is shown by a black arrow. The inlet 12 of the constant flow rate controller 10 is connected to an inner space of the beverage container (not shown) optionally via a riser pipe. When the pressure difference between the inlet 12 and the outlet 14 is large, the flow control part 18 will cover a great part of the orifice 16 such that the effective flow area through the constant flow rate controller 10 is small. When the pressure difference between the inlet 12 and the outlet 14 is small, the flow control part 18 will cover a smaller part of the orifice 16 such that the effective flow area through the constant flow rate controller 10 is large. In this way the flow rate through the constant flow rate controller 10 is approximately constant, i.e. independent of the pressure difference between the inlet 12 and the outlet 14.

The laminar flow conduit 20 will allow any turbulence which may have been formed during the high velocity pass between the inlet 12 and the outlet 14 to decay and prevent the instant generation of large bubbles due to the relative small pressure gradient in the laminar flow conduit 20. The effective flow area of the laminar flow conduit 20 should be slightly larger than the effective flow area between the inlet 12 and the outlet 14. The length of the laminar flow conduit 20 should be significantly longer that the distance between the inlet 12 and the outlet 14 in order to allow a sufficient distance for minimizing the pressure gradient and turbulence formation. The exact dimensions of the constant low rate controller 10 are depending on various factors, such as type of beverage, shape and pressures used, etc.

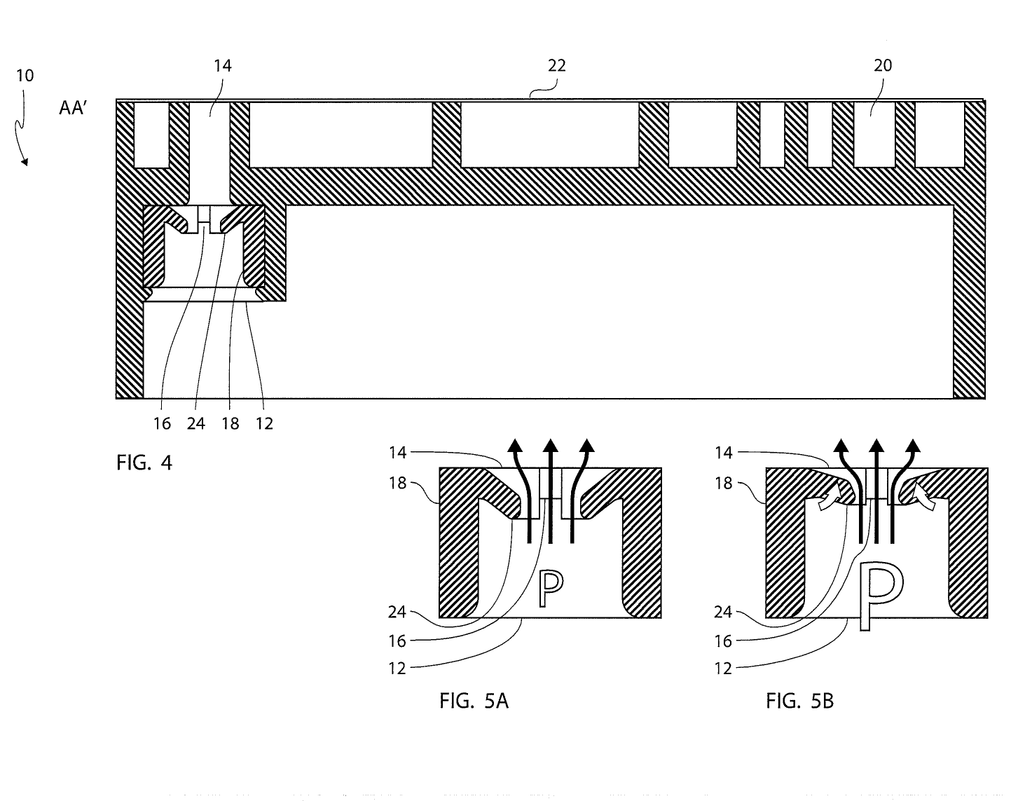

FIG. 4 shows a side cut-out view of a constant flow rate controller 10 when assembled. The flow control part 18 comprises two flow control members 24 which in the present embodiment are constituted by inwardly (in direction of the beverage container) oriented elastic flaps. The constant flow rate controller 10 is preferably made or moulded from plastics. The flow control conduit 20 is visible in the form of a channel. The flow control conduit 20 is sealed off in an upward direction by the rupturable membrane 22. It is contemplated that the flow control conduit 20 may also be closed off by a non-piercable plastic sheet except in the centre region where access to the beverage is required.

FIG. 5A shows a side cut-out view of a first embodiment of a flow control part 18 in the situation where beverage is dispensed having a lower pressure in the beverage container, or when beverage dispensing is interrupted. In this case the elastic flow control members 24 will be relaxed and establish a large effective flow area at the orifice 16 since the pressure difference between the inlet and the outlet is low.

FIG. 5B shows a side cut-out view of a first embodiment of a flow control part 18 in the situation where beverage is dispensed having a higher pressure in the beverage container. In this case the elastic flow control members 24 will be stressed towards the outlet and establish a small effective flow area at the orifice 16 since the pressure difference between the inlet 12 and the outlet 14 is high. This effect is shown by the white arrows, whereas the black arrows show the beverage flow.

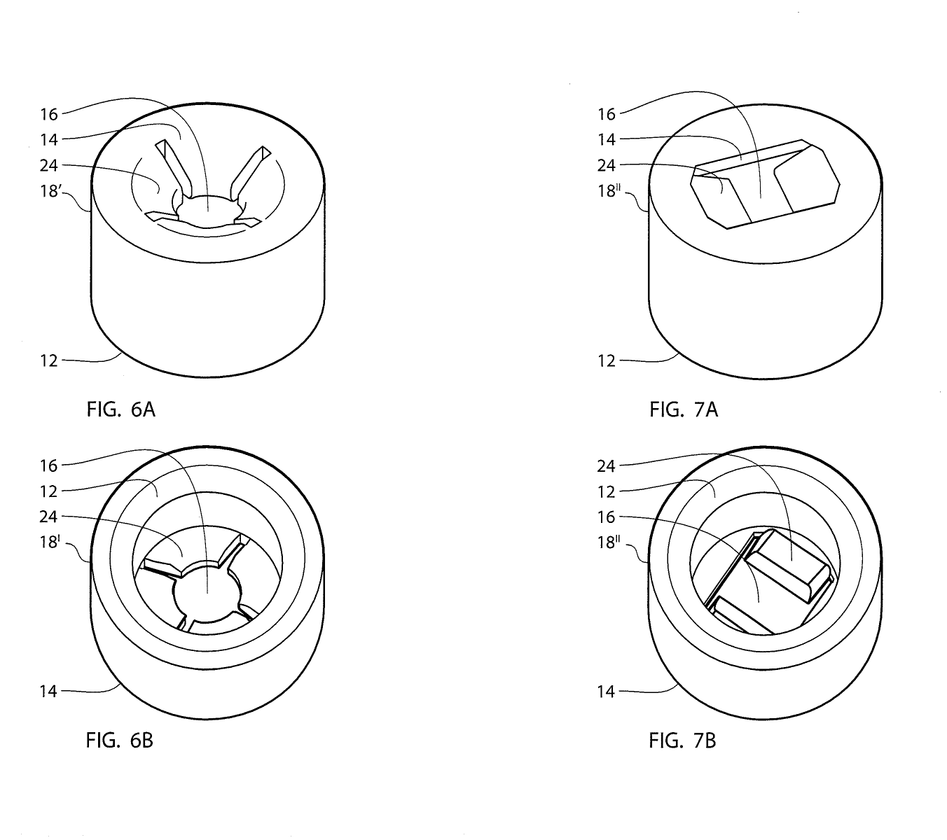

FIG. 6A and FIG. 6B show a perspective front and rear view, respectively, of a second embodiment of a flow control part 18′. The working principle is similar to the previous embodiment, except that the circular orifice 16 is covered by four elastic flow control members 24.

FIG. 7A and FIG. 7B show a perspective front and rear view, respectively, of a third embodiment of a flow control part 18″. The working principle is similar to the previous embodiment, except that the orifice 16 is rectangular and covered by two rectangular elastic flow control members 24.

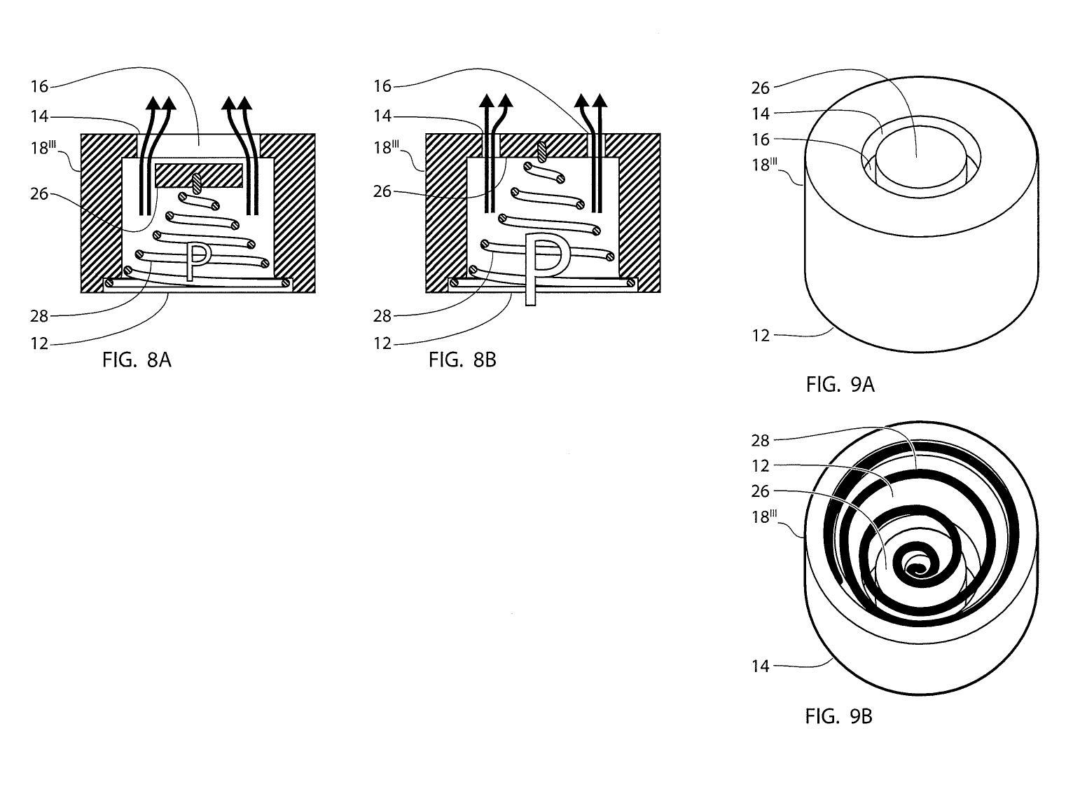

FIG. 8A shows a side cut-out view of a fourth embodiment of a flow control part 18′″ in the situation where beverage is dispensed having a lower pressure in the beverage container or when beverage dispensing is interrupted. The flow control part 18′″ comprises an orifice 16 and a rigid flow control member 26. The rigid flow control member 26 is connected to a spring 28 which in the current situation is relaxed since the differential pressure between the inlet 12 and the outlet 14 is low. The beverage may flow through the orifice 16 as shown by the black arrows. The flow control part 18′″ defines a large effective flow area.

FIG. 8B shows a side cut-out view of a fourth embodiment of a flow control part 18′″ in the situation where beverage is dispensed having a higher pressure in the beverage container. The large pressure difference between the inlet 12 and the outlet 14 results in a great flow through the orifice 16 which causes the rigid flow control member 26 connected to a spring 28 to move towards the orifice 16 thereby stressing the spring 28. A great part of the orifice 16 is thereby covered by the rigid flow control member 26 and the flow control part 18′″ thus defines a small effective flow area.

FIG. 9A and FIG. 9B show a perspective front and rear view, respectively, of the fourth embodiment of a flow control part 18′″. The working principle is similar to the previous embodiments, except that the flow control member 26 is rigid and controlled by a spring 28.

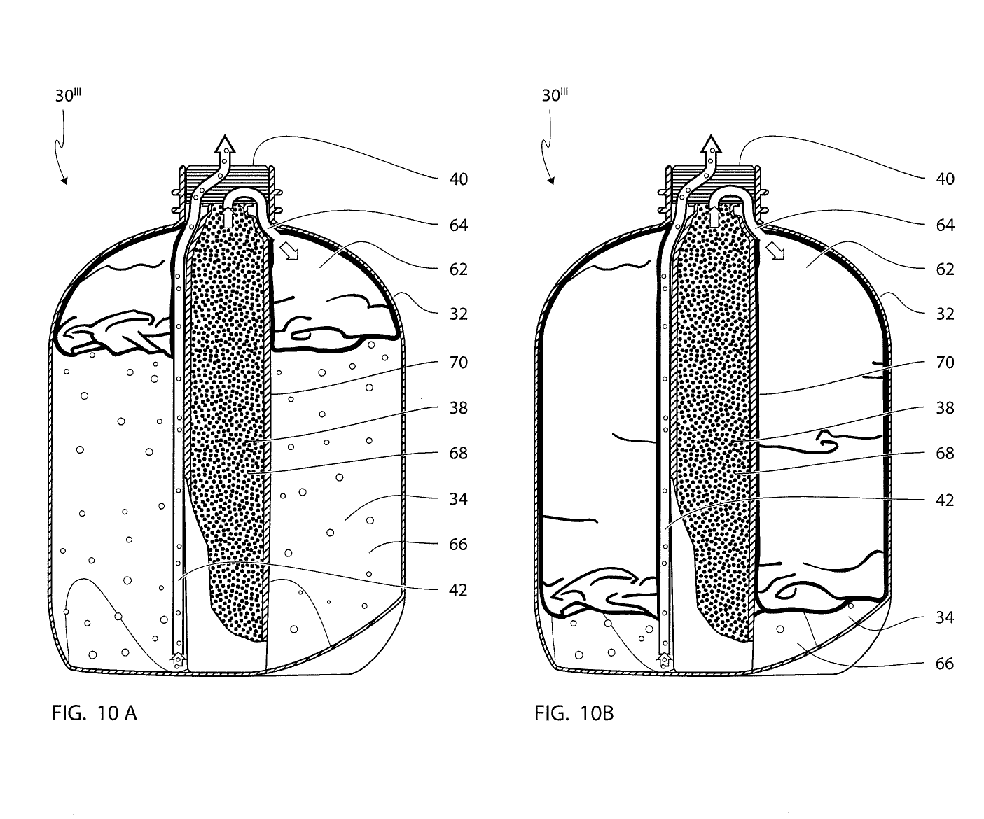

FIG. 10A shows a side view of a beverage dispensing system 30^{III} having a folded bag 62. The inner space 34 comprises a riser pipe 42 extending from the bottom of the container 32 to the lid 40. The canister 38 is filled by activated carbon 68 having adsorbed sufficient CO₂ for replacing all of the beverage 66. The CO₂ propellant gas flows from the canister 38 via the gas connection 64 into the bag 62 as shown by the white arrow. The beverage flows from the bottom of the riser pipe 42 to the top of the lid 40 as shown by the arrow. The top of the lid 40 is preferably connected to a dispensing device (not shown here). The wall 70 of the canister 38 is contacting the bag 62 at a small portion of the wall 70 adjacent the lid 40 and contacting the beverage 66 at a large part of the wall 70 adjacent the bottom of the beverage container 32.

FIG. 10B shows a side view of a beverage dispensing system 30^{III} having an unfolded bag 62. The inner space 34 comprises a riser pipe 42 extending from the bottom of the container 32 to the lid 40. As the CO₂ desorbs from the activated carbon 68, the activated carbon 68 will cool down. The ability of the activated carbon 68 to desorb gas is inhibited by lower temperatures. In order to be able to continuously release CO₂ for replacing the beverage 66 during the dispensing, the adsorption material must be kept at an ambient temperature. As the bag 62 is increasing in volume, a large part of the wall 70 of the canister 38 is contacting the bag 62 and a smaller part of wall 70 of the canister 38 is contacting the beverage 66. The gas within the bag 62 has a low thermal conductivity and a low heat capacity and will thus not be able to heat the activated carbon 68 or transfer any heat from the surrounding beverage 66 to the activated carbon 68. The beverage 66, on the other hand, comprises a large part of water which has a high thermal conductivity and a high heat capacity. In order to provide heat to the activated carbon 68 during the desorption of gas caused by the dispensing of beverage, the riser pipe 42 is led adjacent the wall 70 of the canister 38. The beverage within the riser pipe 42 will thus flow adjacent the wall 70 of the canister 38 and, consequently, there will be a heat transfer from the beverage 66 to the activated carbon 68 through the wall 70. The activated carbon 68 will thus be kept at a high temperature and desorption will not be interrupted due to low temperature of the adsorption material.

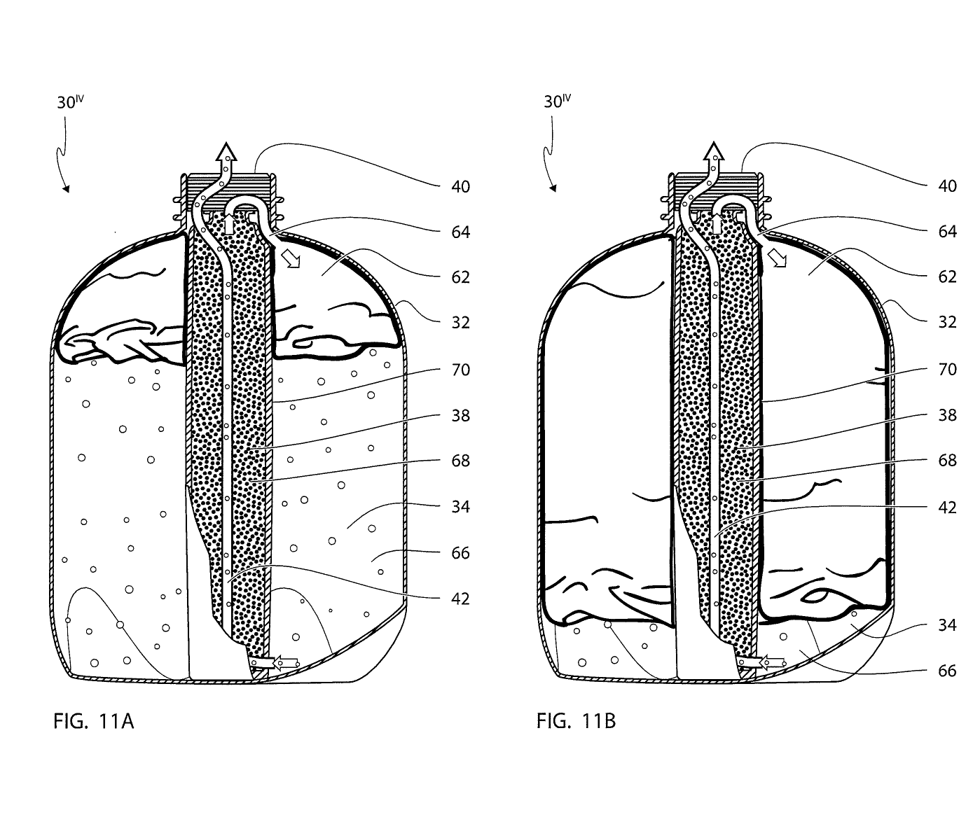

FIG. 11A and FIG. 11B each shows a side view of a beverage dispensing system 30^{IV} having a central riser pipe 42 wherein the bag 62 is folded and unfolded, respectively. The riser pipe 42 is led through the interior of the canister 38 thereby allowing heat to be transferred from the beverage 66 to the activated carbon 68.

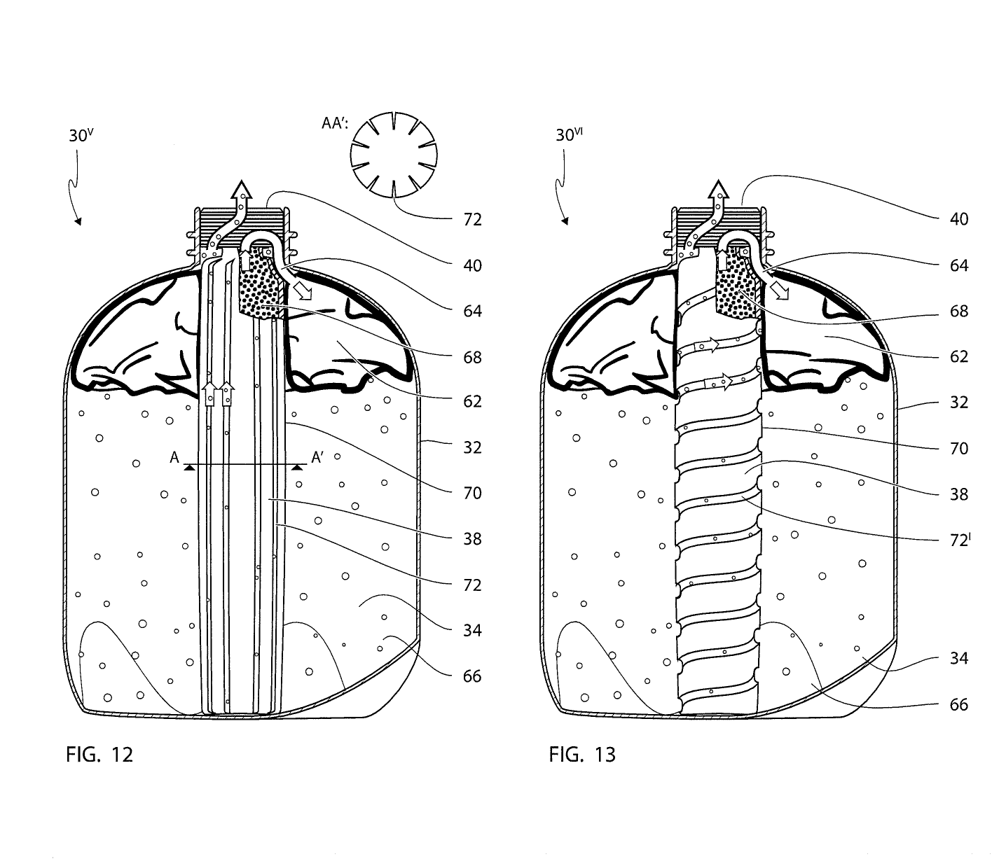

FIG. 12 shows a side view of a beverage dispensing system 30^{V} in which the canister 38 has straight line grooves 72 extending from the bottom of the canister 38 adjacent the bottom of the container 32 to the top of the canister 38 adjacent the lid 40. The bag 62 will block fluid communication between the inner space 34 and the lid 40. The beverage 66 will thus flow within the straight line grooves 72 and will thus flow adjacent the wall 70 of the canister 38 and consequently there will be a heat transfer from the beverage 66 to the activated carbon 68 through the wall 70.

FIG. 13 shows a side view of a beverage dispensing system 30^{VI} in which the canister 38 has a helical groove 72′ extending from the bottom of the canister 38 adjacent the bottom of the container 32 to the top of the canister 38 adjacent the lid 40. The bag 62 will block fluid communication between the inner space 34 and the lid 40. The beverage 66 will thus flow within the helical groove 72′ and will thus flow adjacent the wall 70 of the canister 38 and consequently there will be a heat transfer from the beverage 66 to the activated carbon 68 through the wall 70.

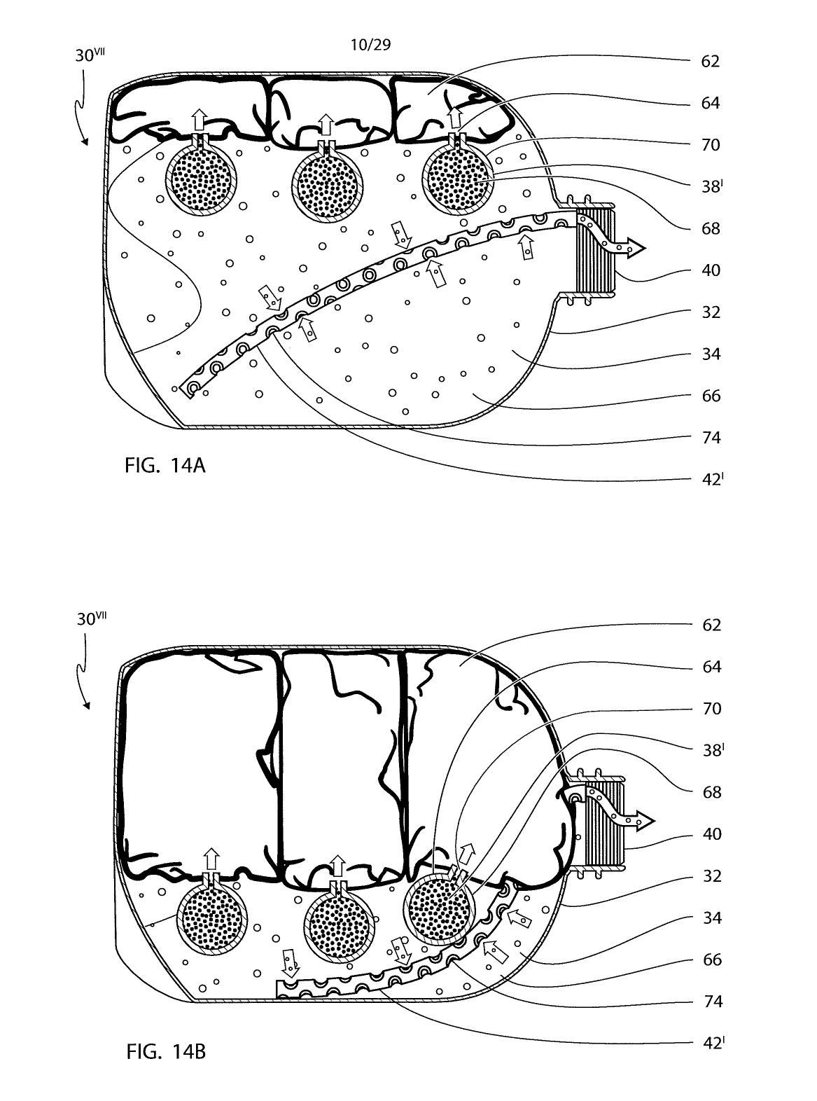

FIG. 14A shows a side view of a beverage dispensing system 30^{VII} having several, presently three, ball shaped canisters 38′ filled with activated carbon 68. Each of the ball shaped canisters 38′ have a respective bag 62 attached via a gas connection 64. The bags 62 may or may not be attached to the wall of the container 32. A riser pipe 42′ extends from the lid 42 towards the bottom of the container 32. The riser pipe 42 has several holes 74 for allowing beverage 66 to enter the riser pipe 42.

FIG. 14B shows a side view of the above beverage dispensing system 30^{VII} having several ball shaped canisters 38′ filled by activated carbon 68 after most of the beverage 66 has been dispensed. The bags 62 have increased in volume so that the canisters 38′ are pushed sideward and the riser pipe 42′ is bent sideward. The bags 62 and canisters 38 block the direct access to the lid 40 and thus the riser pipe 42′ provides a fluid path for the beverage 66 to flow to the lid 40. The canisters 38′ are kept in contact with the beverage to a large extent such that heat from the beverage 66 may be transferred to the activated carbon 68.

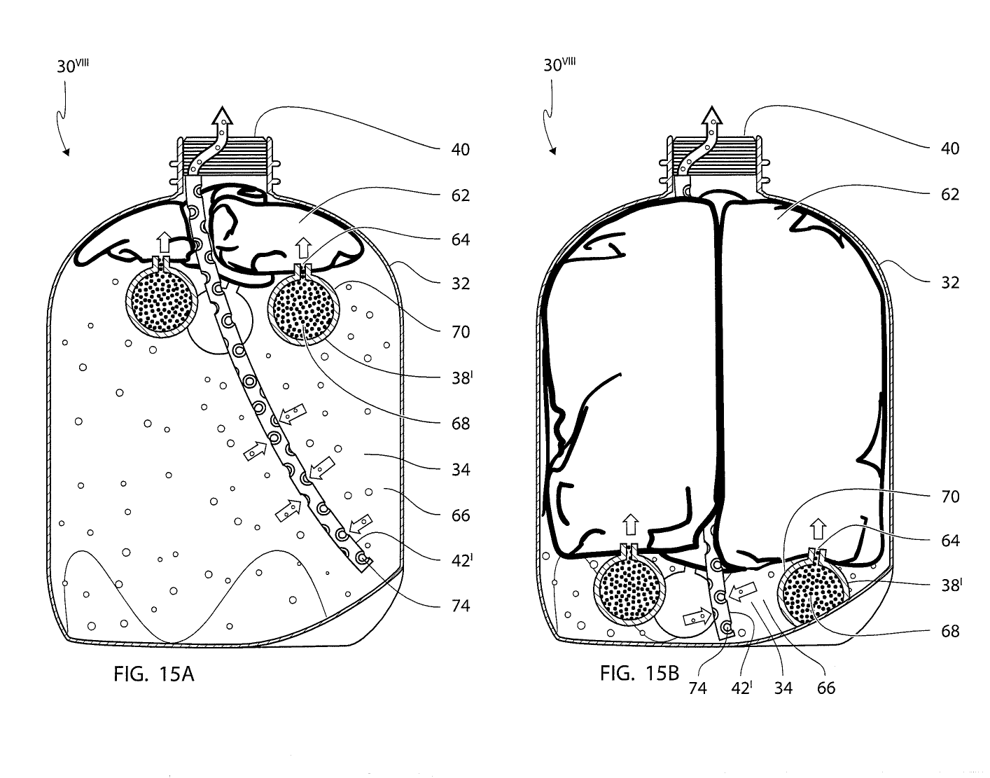

FIG. 15A and FIG. 15B each shows a side view of another beverage dispensing system 30^{VIII} having several canisters, wherein the bags 62 are folded and unfolded, respectively. The present embodiment differs from the previous embodiment only by the position of the bags 62 and canisters 38′, which in the present embodiment as relocated adjacent and optionally fastened at the top portion of the container 32 adjacent the lid 40. The bags 62 are unfolding towards the bottom of the container 32, i.e. opposite the lid 40. Consequently, the canisters 38′ are also pushed towards the bottom of the container 32. The riser pipe 42′ allows a fluid passage for the beverage towards the lid 40. The canisters 38′ are kept in contact with the beverage to a large extent such that heat from the beverage 66 may be transferred to the activated carbon 68.

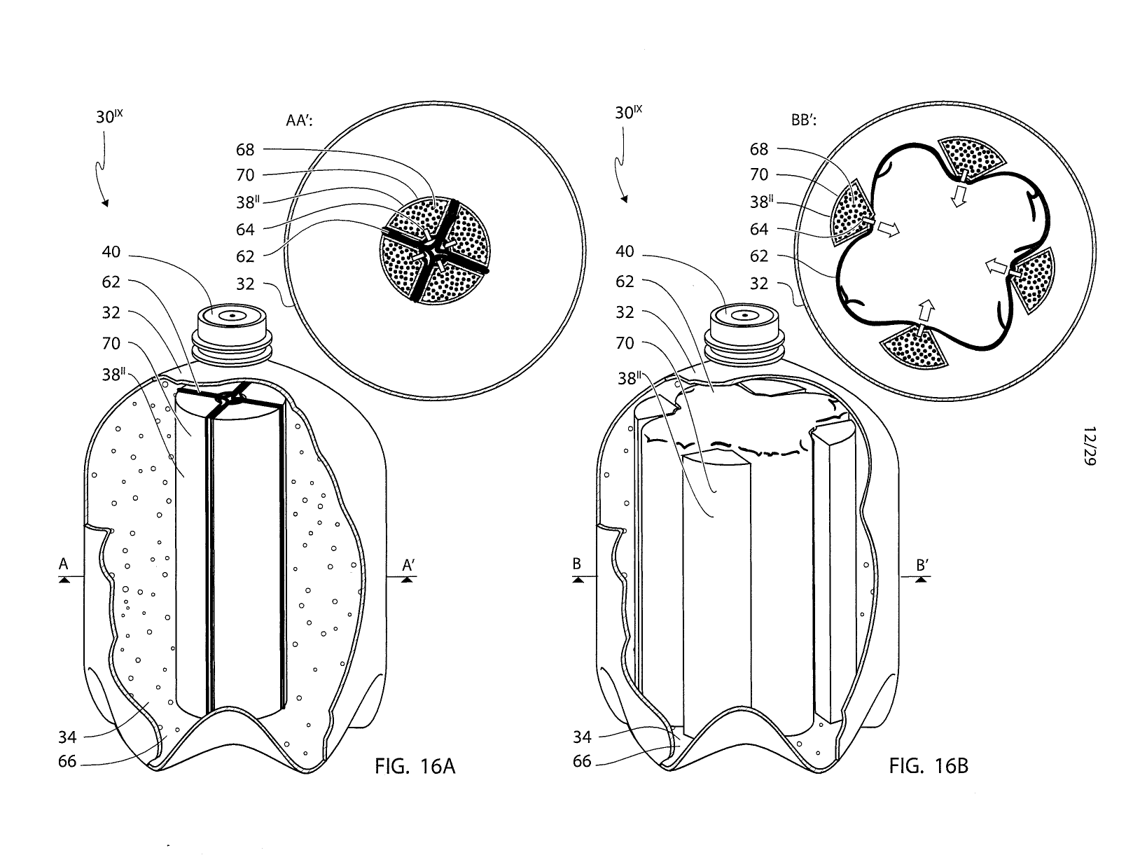

FIG. 16A shows a side view of a beverage dispensing system 30^{IX} having a central bag 62 onto which a plurality, such as four, canisters 38″ have been fastened. All of the canisters 38″ are connected to the common bag 62 by a separate gas connection. Initially, the bag 62 is folded in-between the canisters 38″.

FIG. 16B shows a side view of the beverage dispensing system 30^{IX} having a central bag 62 as described above. When the beverage is being dispensed, the common bag 62 is unfolded and pushes the canisters 38″ in an outward direction within the inner space 34. The canisters 38″ separate from each other and expose a large surface to the beverage 66 in order to provide heat to the adsorption material within the canisters 38″.

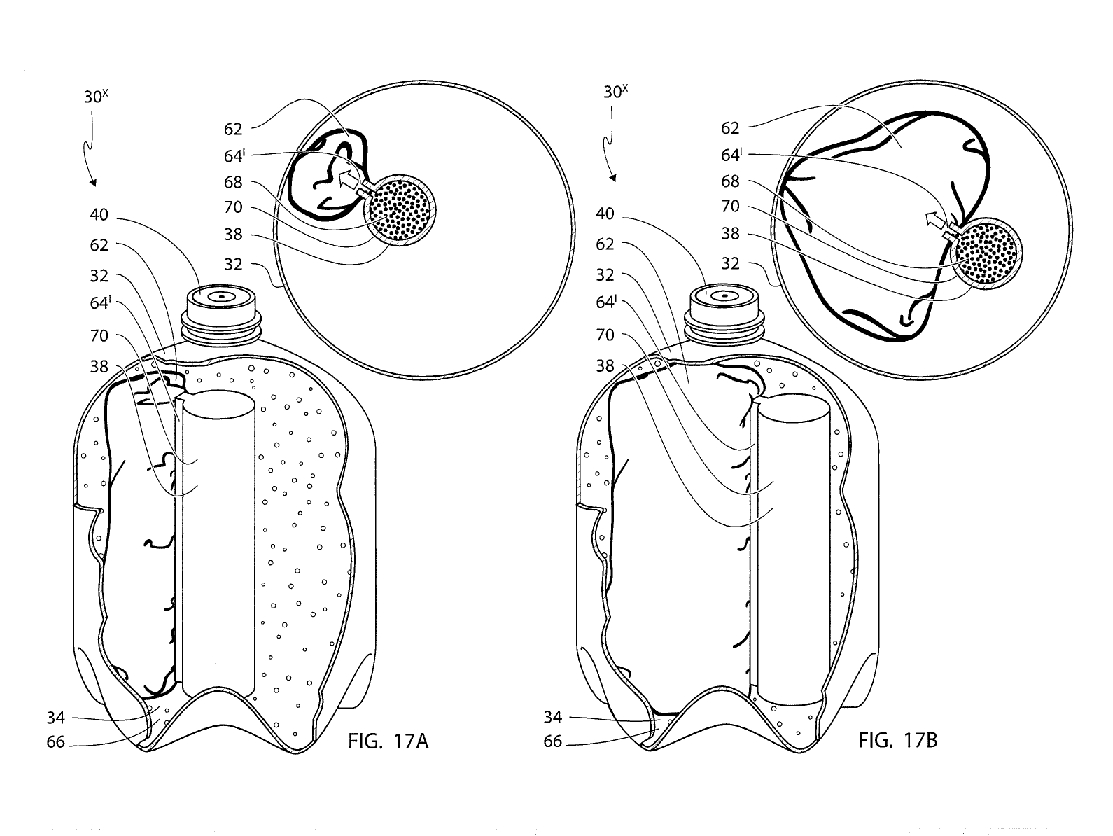

FIG. 17A and FIG. 17B each shows a side view of a beverage dispensing system 30^{X} having a bag 62 which is fastened to the canister 34, wherein the bags 62 are folded and unfolded, respectively. The canister 34 and the bag 62 are connected via an elongated gas connection 64′.

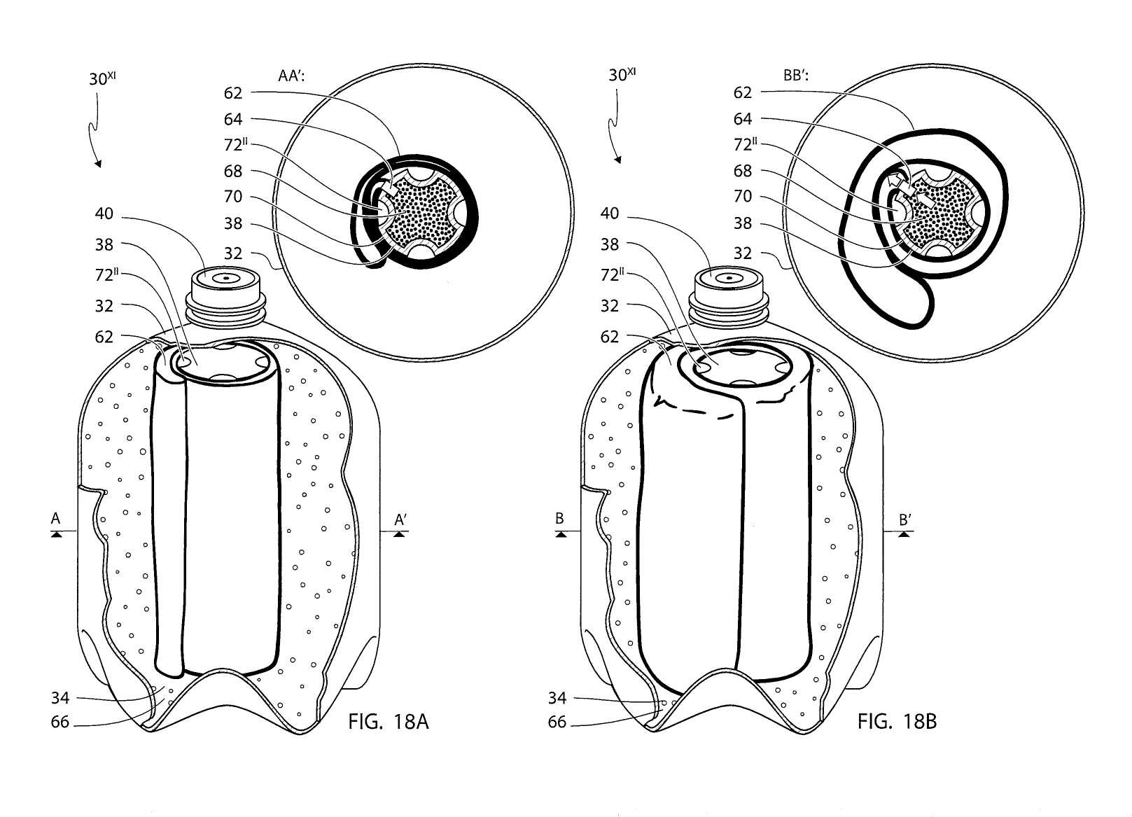

FIG. 18A and FIG. 18B each shows a side view of a beverage dispensing system 30^{XI} having a bag 62 which is rolled around the canister 34, wherein the bags 62 are folded and unfolded, respectively. The wall of the canister 38 is provided with straight line grooves 72″ extending from the bottom to the top of the canister in order to allow beverage 66 to heat the activated carbon 68 within the canister 38^{XI}.

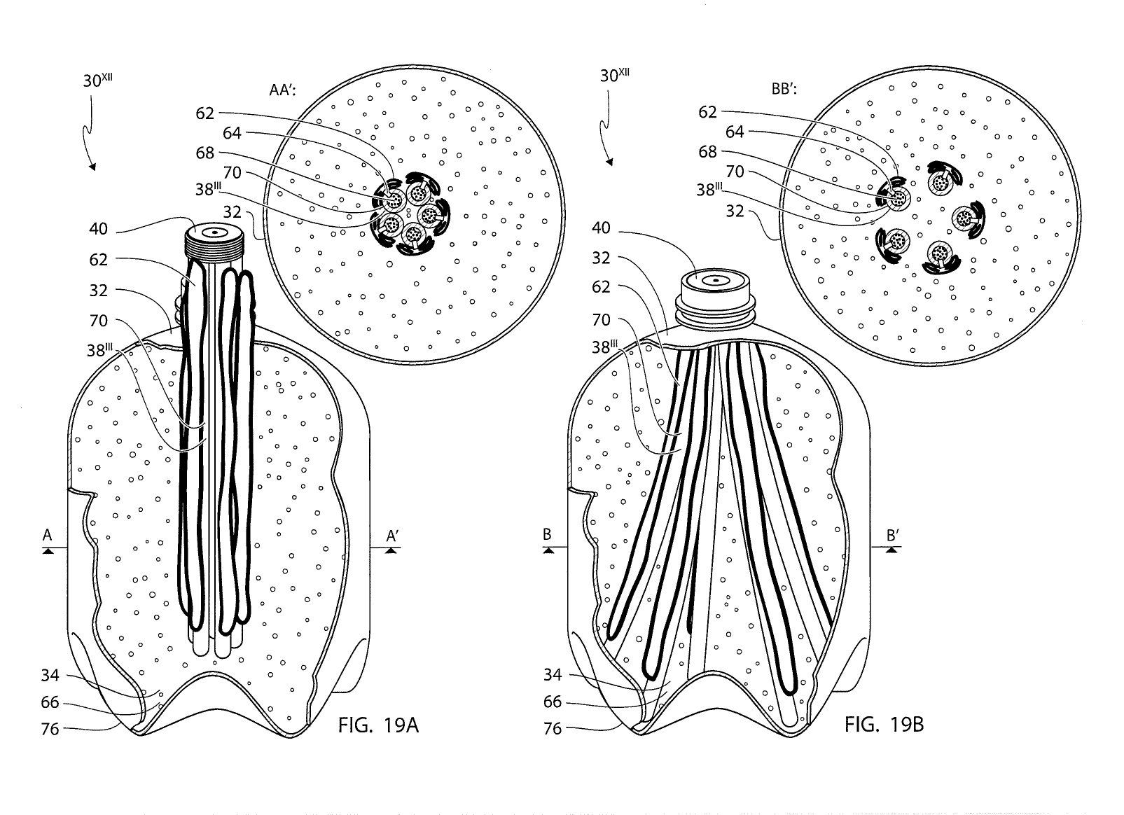

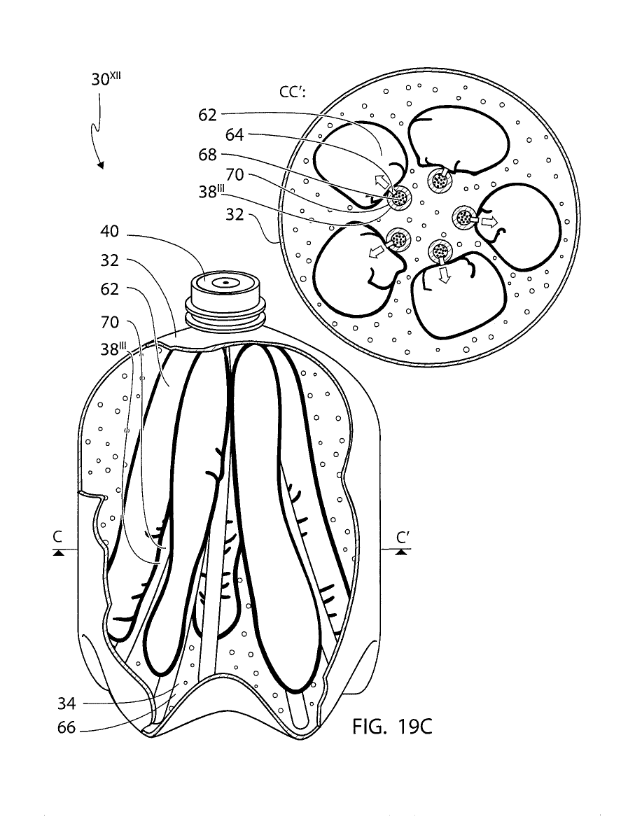

FIG. 19A shows a beverage dispensing system 30^{XII} having elongated canisters 38′″ each having an attached bag 62. The elongated canisters 38′″ are slightly longer than the distance between the top and the bottom of the container 32.

FIG. 19B shows a beverage dispensing system 30^{XII} having elongated canisters 38′″ each having an attached bag 62. The elongated canisters 38′″ have been inserted into the container 32, thereby separating the individual canister 38′″ and allowing each canister 38′″ to be positioned contacting the bottom of the beverage container 32 within a respective bottom curvature 76. In this way a longer set of canisters 38′″ may be used.

FIG. 19C shows a beverage dispensing system 30^{XII} having elongated canisters 38′″ wherein the bags 62 are unfolded while maintaining contact between the beverage 66 and the canister 38″

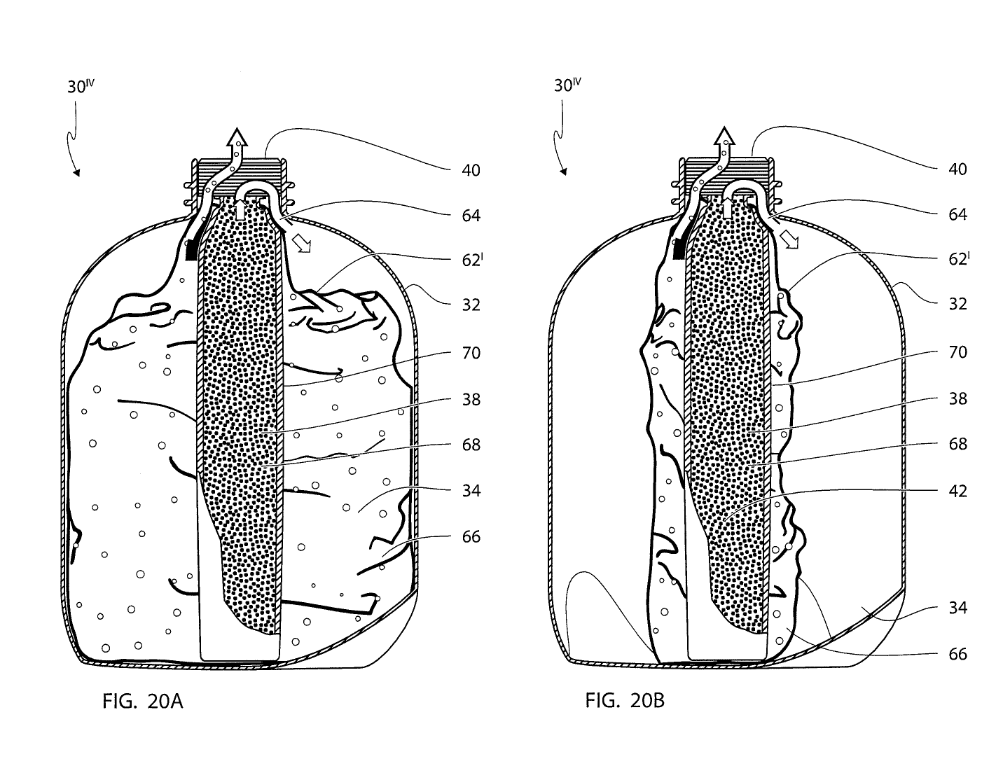

FIG. 20A shows a side view of a beverage dispensing system having a beverage filled bag 62′. The beverage filled bag 62′ is connected to the outside via the lid 40. The canister 38 is connected to the inner space 34 via a gas connection 64.

FIG. 20B shows a side view of a beverage dispensing system having a beverage filled bag 62′. As the beverage 66 is being dispensed from the bag 62′, the propellant gas flows from the canister 38 to the inner space 34 surrounding the bag 62′. The bag 62′ is being folded as the beverage 66 is being dispensed. The bag is fastened adjacent the canister 38 and folded towards the canister 38 so that thermal contact is maintained between the beverage 66 and the activated carbon 68 within the canister 38. In this way the activated carbon 68 is heated by the beverage 66.

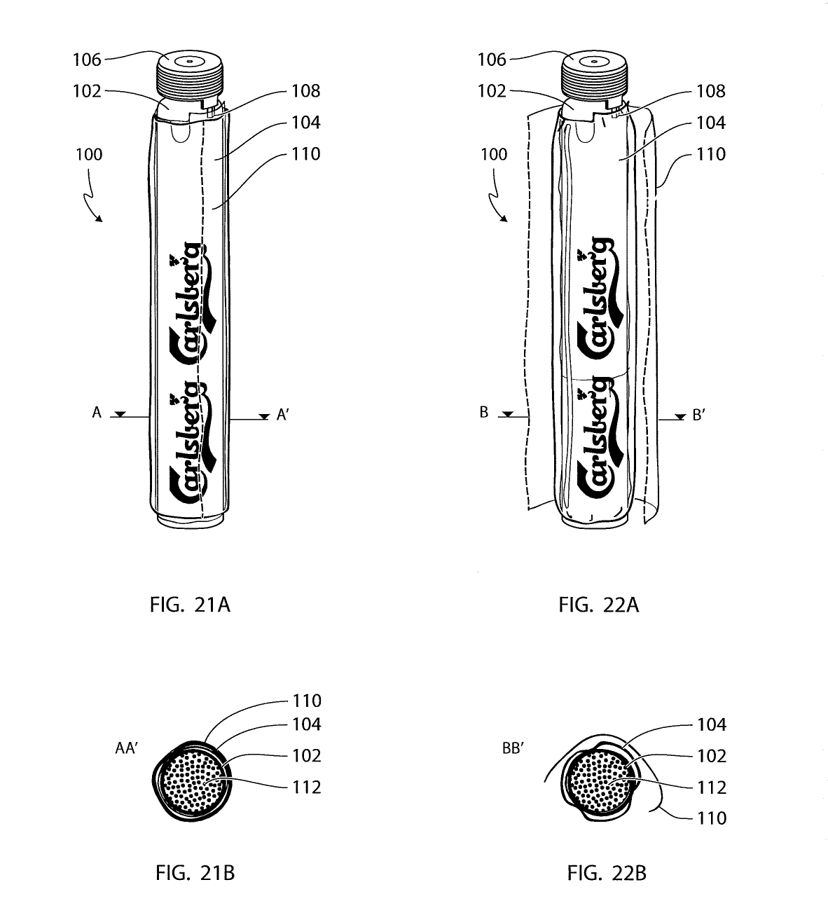

FIG. 21A shows a perspective view of a pressurization system 100. The pressurization system 100 comprises a canister 102 which is surrounded by a folded bag 104. The canister 100 is closed off by a lid 106 which is connected to a gas inlet 104 of the bag 104 for providing a gas passage from the canister 102 to the bag 104. The bag 102 is being held in place by a ribbon 110 which is encircling the bag 104. The lid 106 may also be used for closing off the beverage container (not shown). In the present embodiment the bag has been printed with the word “Carlsberg” using a thermocromic dye for the purpose of temperature indication. It may be difficult to know when the beverage is cool enough for drinking as the large containers used with the present pressurization system cool down slower than conventional bottles. By using a thermocromic dye which changes colour at the suitable dispensing temperature, an indicator is achieved informing the user of the temperature of the beverage. The print is made on the inside of the bag in order to prevent possible contamination of the beverage.

FIG. 21B shows a top view of the pressurization system 100. The canister 102 is filled by activate carbon 112 which have adsorbed a specific amount of carbon dioxide. The specific amount of carbon dioxide should yield a sufficient dispensing pressure and allow the beverage in the beverage container (not shown) to be replaced by the carbon dioxide in the bag 104.

FIG. 22A shows a perspective view of the pressurization system 100 when the ribbon 110 has been removed from the bag 104. The ribbon 110 is welded onto the bag 104 and holds the bag in place around the canister 102 before the pressurisation system 100 has been activated inside the beverage container (not shown). The ribbon 110 has a predetermined breaking point which breaks when the bag 104 is being pressurized during activation of the pressurization system 100 within the beverage container (not shown).

FIG. 22B shows a top view of the pressurisation system 100 when the ribbon 106 has been removed and the bag 104 starts to inflate and unfold about the canister 102. The inflating bag 102 will assume a dispensing pressure onto the beverage and replace the beverage as the beverage is being dispensed from the beverage container.

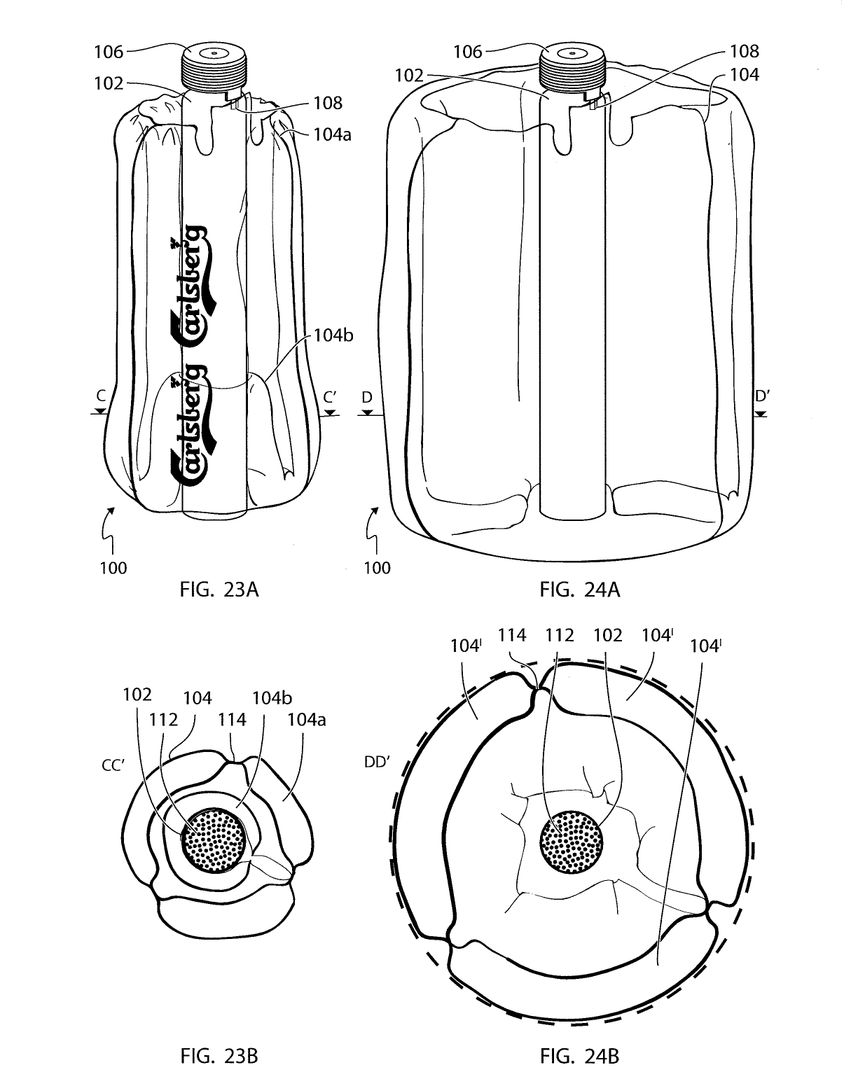

FIG. 23A shows a perspective view of the pressurisation system 100 when the bag 104 has been partially unfolded and some gas has flowed from the canister 102 to the bag 104 thereby inflating the bag 104. The bag 104 comprises a bag top 104a and a bag bottom 104b. The bag bottom 104b is in the non-activated state folded inwardly towards the canister 102.

FIG. 23B shows a top view of the pressurization system 100 when the bag 104 has been unfolded and some gas has flowed from the canister 102 to the bag 104 thereby inflating the bag 104.

FIG. 24A shows a perspective view of the pressurization system 100 when the bag 104 has been fully unfolded and partly inflated. The bag bottom 104b has now been unfolded. The bag 102 forms a substantially ring shaped body encircling the canister 102.

FIG. 24B shows a top view of the pressurization system 100 when the bag 104 has been fully unfolded and partly inflated. The dashed circle represents the outer circumference of the beverage container. The bag 104 will fold out adjacent the beverage container. The bag 104 is split up into separate internal spaces 104′ by welds 114. The internal spaces 104′ are interconnected.

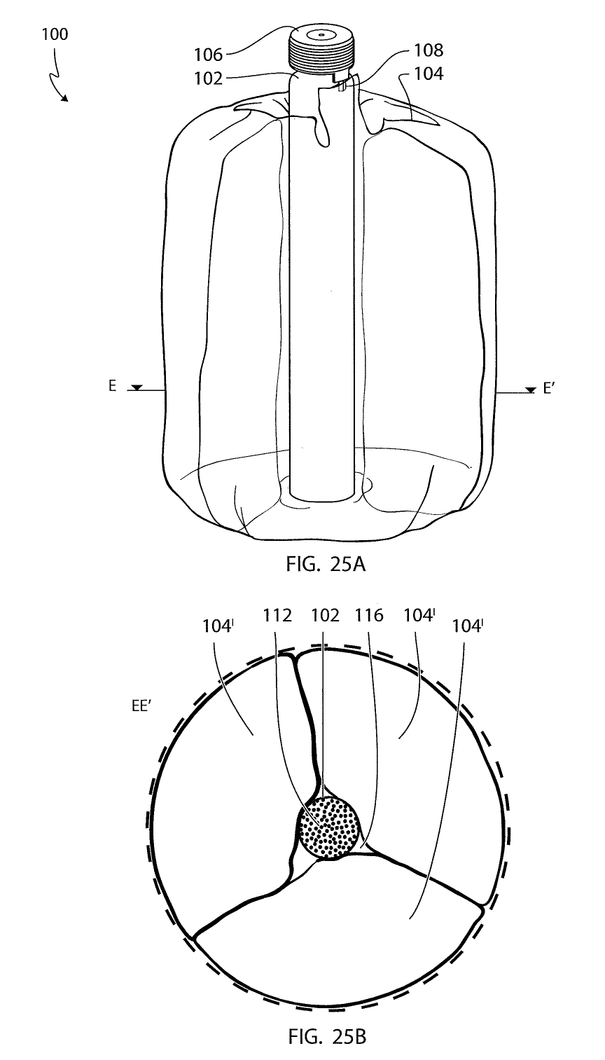

FIG. 25A shows a perspective view of the pressurization system 100 when the bag 104 has been fully inflated.

FIG. 25B shows a top view of the pressurization system 100 when the bag 104 has been fully inflated. The bag is thus pressurized and thus the individual spaces 104′ of the bag 104 are contacting both the beverage container and the canister 102. Due to the welds 114, the bag 104 and the canister 102 will form channels 116 adjacent the canister 102 forming a virtual ascending pipe for allowing beverage to flow from the bottom of the beverage container to the beverage outlet adjacent the lid.

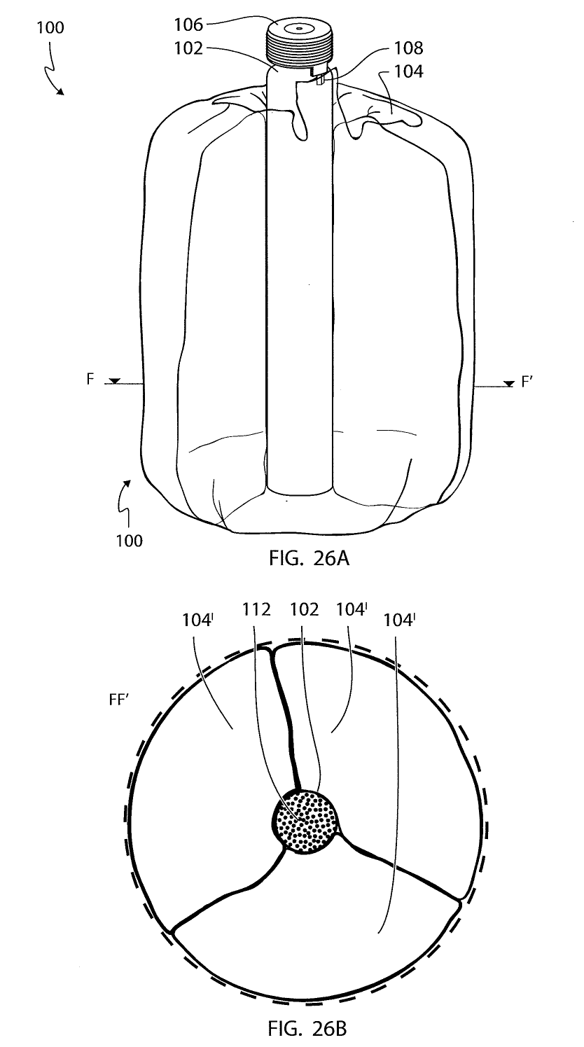

FIG. 26A shows a perspective view of the pressurization system 100 when the entire beverage has been dispensed.

FIG. 26B shows a top view of the pressurization system 100 when the entire beverage has been dispensed. The last of the beverage present in the channels adjacent the canister 102 will be dispensed, thereby allowing the bag 104 to fill the entire beverage container.

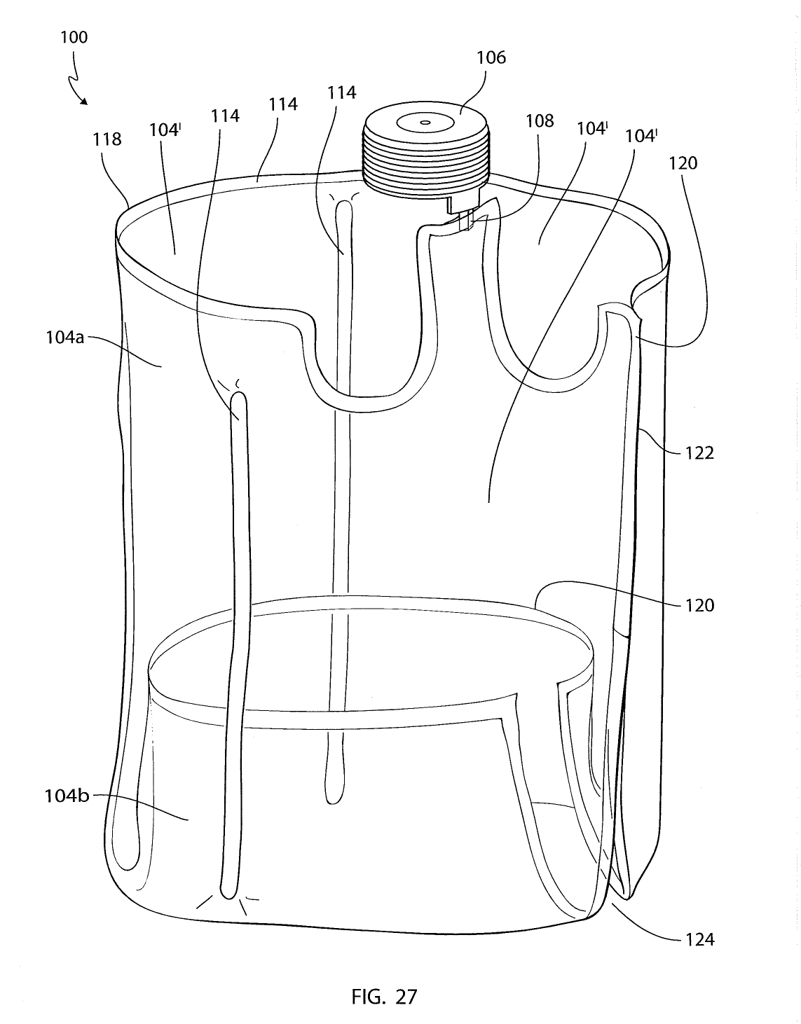

FIG. 27 shows a perspective view of the pressurization system 100 when the bag 104 is unfolded but not inflated about the canister (not shown) it is shown that the bag 104 has a genresally ring formed shape and that the bottom 104b is folded inwardly within the ring formed by the upper bag 104a in order to reduce the length of the bag 104 allowing the bag 104 to be folded about the canister. Also, the welds 114 are shown extending partially between an upper edge 118 and a lower edge 120 of the bag 104 thereby forming internal spaces 104′ which are interconnected. The bag 104 is made of two opposing cylindrical foils which are welded at the upper edges 118 and lower edges 120 forming a ring structure. The present embodiment is also welded at the side edges 122 and forms a slit 124 which allows the bag bottom 104b to fold out.

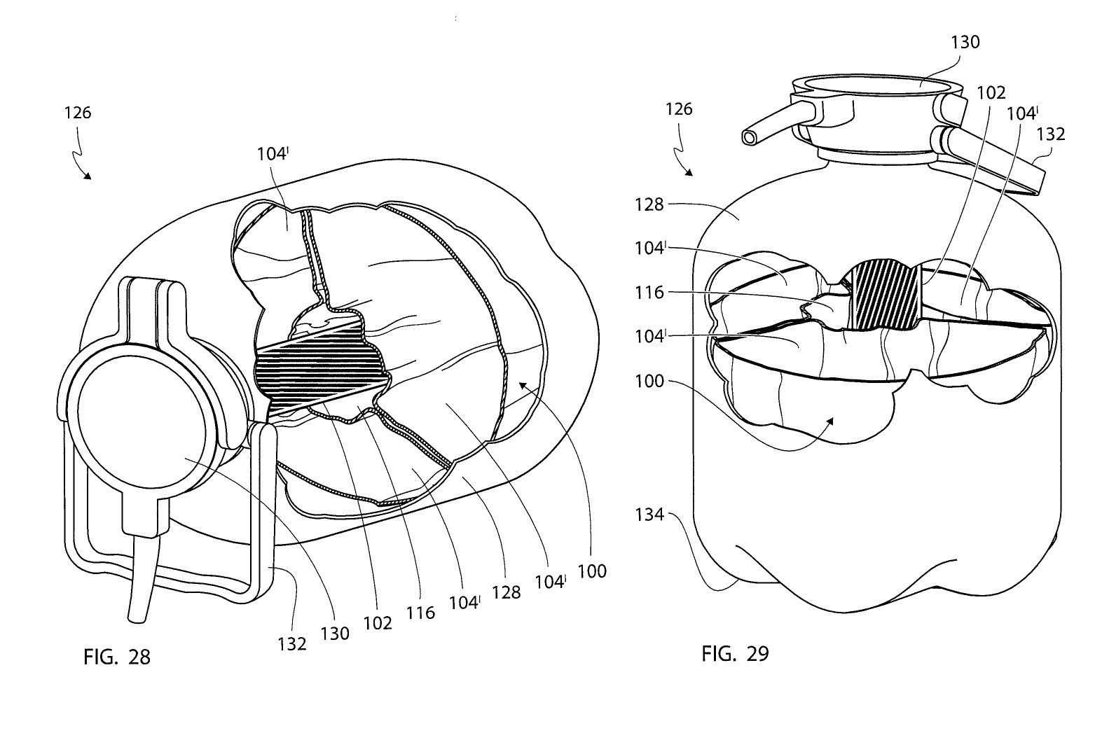

FIG. 28 shows a perspective view of a beverage dispensing system 126. The beverage dispensing system 126 comprises a beverage container 128 including a beverage and the pressurization system 100. The beverage dispensing system 126 further comprises a dispensing device 130 for allowing the beverage to flow from the container 128 to the outside. The beverage dispensing system 126 further comprises a handle 132 for carrying the beverage dispensing system 126. The present beverage dispensing system 126 is located in a horizontal position and rests on the handle 132 which prevents the beverage container 128 from rolling.

The bag 104 and the canister 102 are located inside the container 128. The bag 104 connected to the canister 102 provides a dispensing pressure for forcing the beverage out of the container when the dispensing device 130 is activated. The dispensing device 130 includes a valve for controlling the flow of beverage out of the container 128. As the beverage is being dispensed, carbon dioxide gas will desorb from the activated carbon inside the canister 102 and flow from the canister 102 into the bag 104. As the bag inflates, the bag 104 and the canister 102 will form a channel 116 for allowing beverage to flow adjacent the canister and thereby prevent the activated carbon to assume a low temperature which would inhibit the desorption. The channel 116 is a result of the welds preventing the bag 104 from forming a perfect toroid.

FIG. 29 shows a perspective view of a beverage dispensing system 126. The beverage dispensing system 126 is now in a vertical orientation standing on the base 134. The channel 116 now functions as an ascending pipe allowing beverage to flow from the bottom of the container 128 to the dispensing device 130 at the top of the container 128. The present beverage dispensing system 126 is thus positionable in both the horizontal as well as the vertical position.

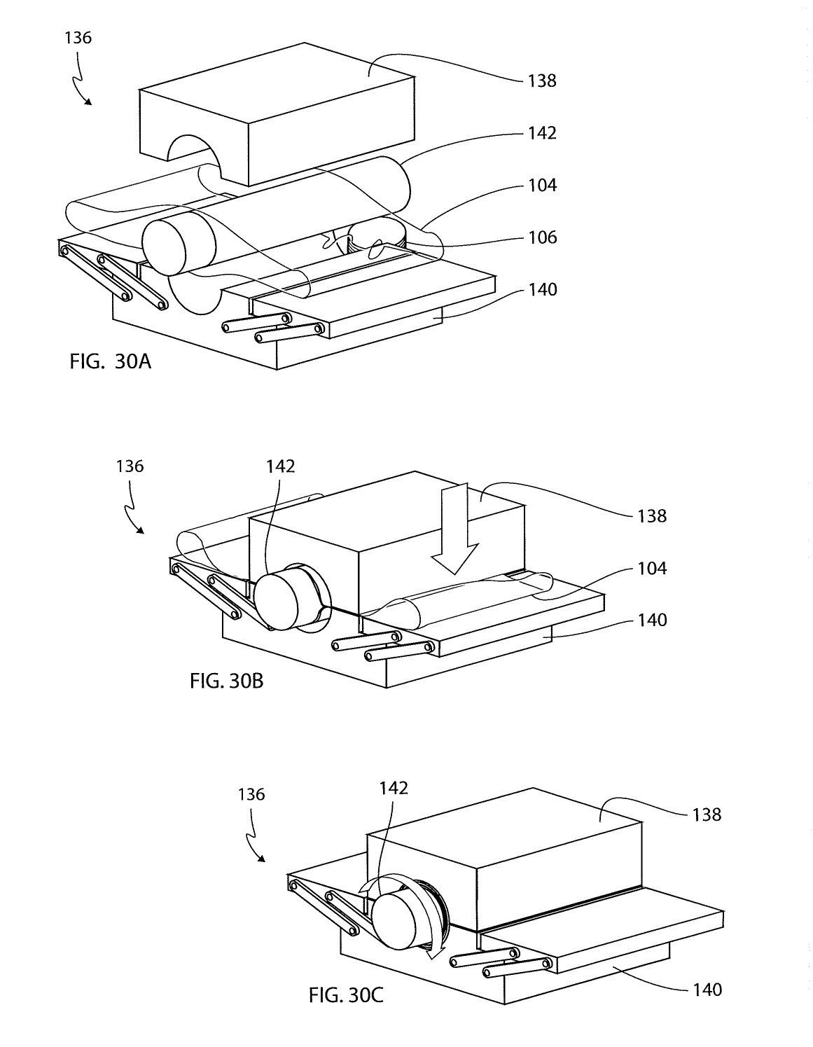

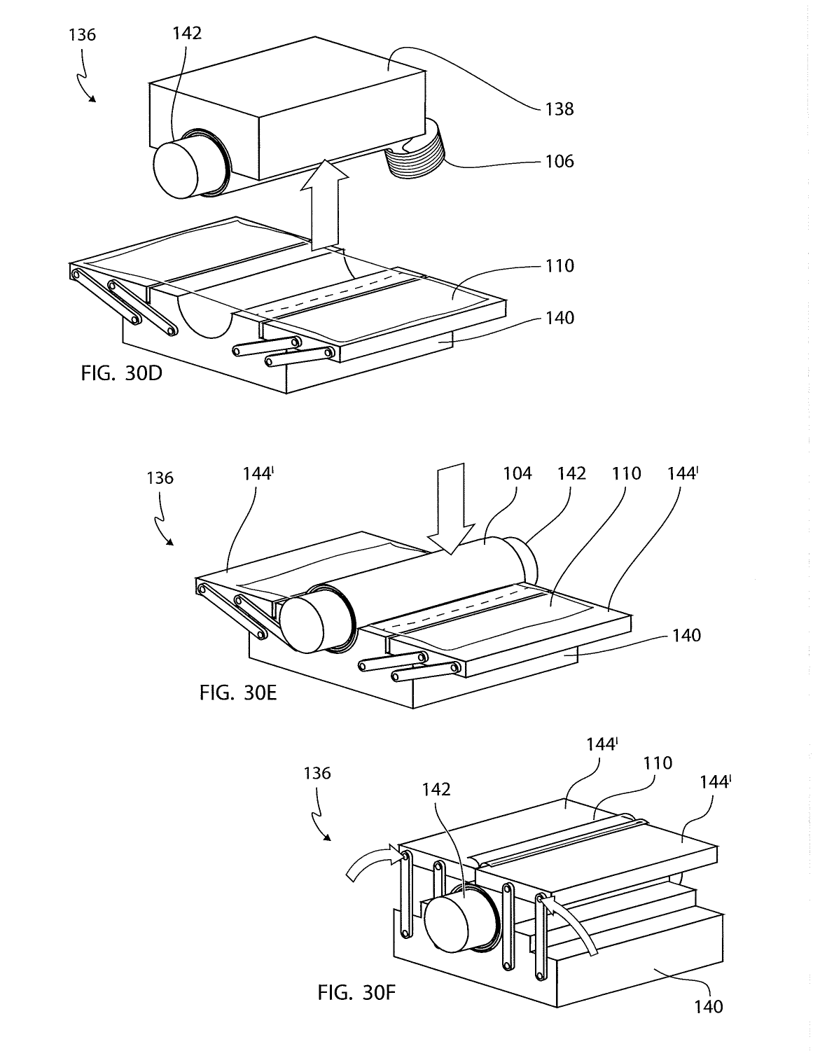

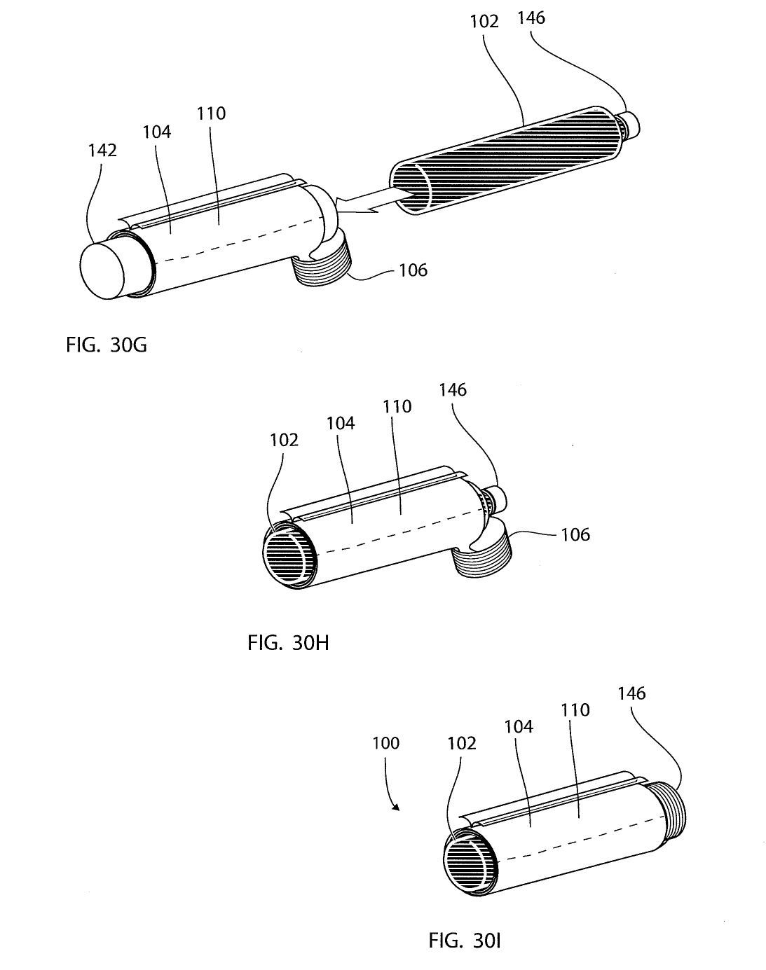

FIG. 30A shows a first mounting setup 136 for the first method of preparing the pressurization system by folding the bag 104 about the canister 102. The setup 136 comprises a top part 138, a bottom part 140, and a vacuum roller 142 located inbetween the top part 138 and the bottom part 140. The bag 104 is positioned encircling the vacuum roller 142 and inbetween the top part 138 and the bottom part 140.

FIG. 30B shows the setup 136 when the bag 104 has been attached to the vacuum roller 142 by applying low pressure to the surface of the vacuum roller 142. The top part 138 and the bottom part 140 have cavities such that the bag 104 and the vacuum roller 142 may fit between the top part 138 and the bottom part 140.

FIG. 30C shows the setup 136 when the bag 104 has been rolled up about the vacuum roller 142 by rotating the vacuum roller 142 while applying low pressure onto the surface of the vacuum roller 142.

FIG. 30D shows the setup 136 when the top part 138, the bag 104 and the vacuum roller 142 have been lifted and a ribbon 110 has been placed on the bottom part 140.

FIG. 30E shows the setup 136 when the bag 104 and the vacuum roller 142 have been replaced on the bottom part 140. The ribbon rests on top of two opposing movable welders 144 144′ being part of the bottom part 140.

FIG. 30F shows the setup 136 when the two opposing movable welders 144 144′ have been moved towards each other and welded the ribbon 110 about the bag 104.

FIG. 30G shows the setup 136 when the vacuum roller 142 has been repressurized for releasing the bag 104.

FIG. 30H shows the setup 136 when the vacuum roller 142 has been removed and replaced by the canister 102. The canister 102 has a cap 146 for preventing the gas from escaping during assembly of the pressurization system.

FIG. 30I shows the setup 136 when the lid 106 of the canister 102 has been placed on the cap 146 of the canister 102. The pressurization system 100 is thus ready for being installed in the container of the beverage dispensing system.

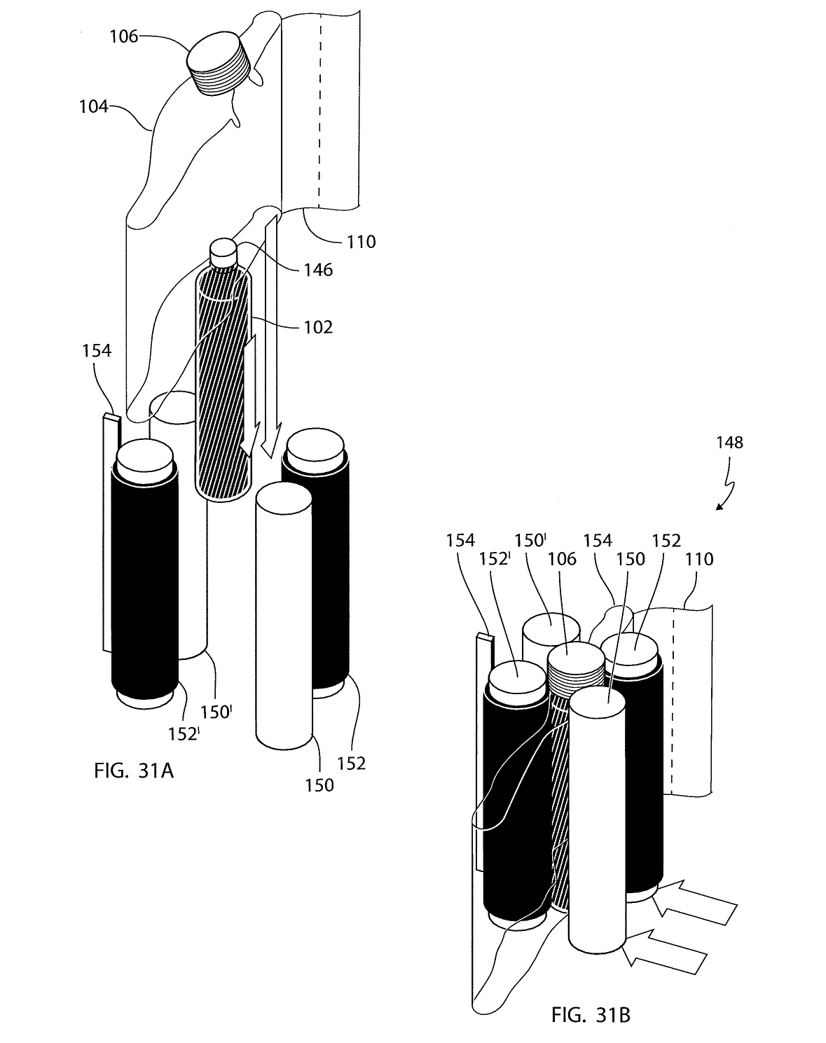

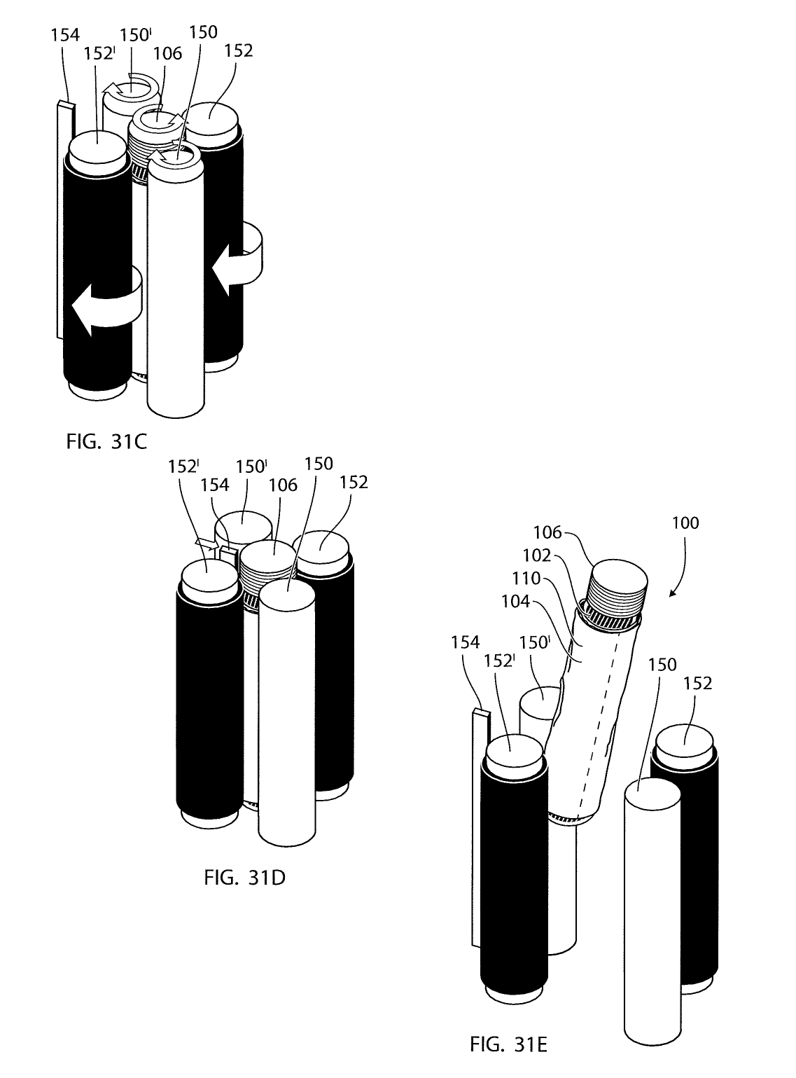

FIG. 31A shows a second mounting setup 148 for the second method of preparing the pressurization system by folding the bag 104 about the canister 102. The setup 148 comprises two opposing non-driving rollers 150 150′ and two opposing driving rollers 152 152′. The bag 104 is assembled around the canister 102 and the bag 104 and canister 102 are in turn positioned inbetween the rollers 150 150′ 152 152′ which are positioned equidistant about the bag 104 and canister 102.

FIG. 31B shows the second mounting setup 146 when the rollers 150 150′ 152 152′ have moved towards and contacting the bag 104 and canister 102. The ribbon 110 is in the present embodiment welded to the bag 104.

FIG. 31C shows the second mounting setup 146 when the rollers 150 150′ 152 152′ rotate as shown by the arrows and thereby fold the bag 104 about the canister 102.

FIG. 31D shows the second mounting setup 146 when a welder 154 welds the ribbon 110 such that the bag 104 may not unfold when removed from the setup 148.

FIG. 31E shows the second mounting setup 146 when the pressurization system 100 is removed from the setup 146.

It is understood that also in the previous embodiment showing the first setup the ribbon may be welded to the bag just as well as it is feasible that the ribbon in the present second setup is not welded to the bag but just inserted after folding.

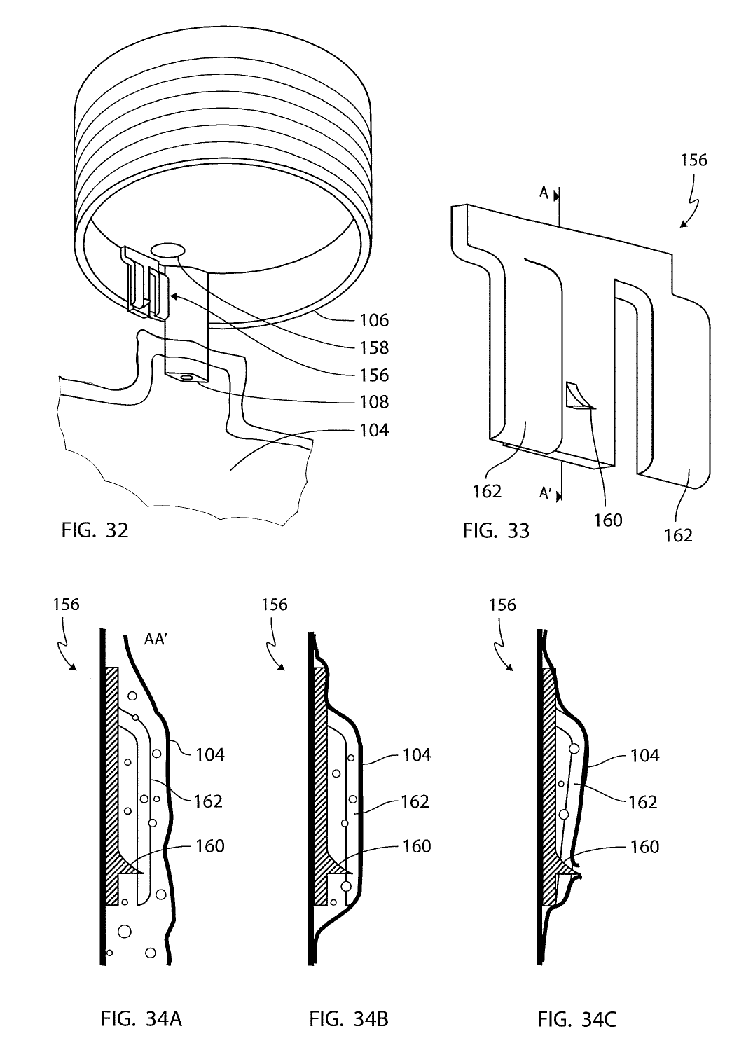

FIG. 32 shows the lid 106 being equipped with an optional piercing device 156 for piercing the bag 104 when all of the beverage has been dispensed through the beverage outlet 162.

FIG. 33 shows a perspective view of the piercing device 156. The piercing device 156 comprises a piecing member 160 and two opposite flexible members protecting the bag from unintentional piercing.

FIG. 34A shows a side view of the piercing device 156 when the bag 104 is approaching the piercing device 156 when there is still plenty of all beverage to be dispensed from the container (not shown). As the pressure is equal both outside and inside the bag 104, the bag will not move adjacent the piercing device 156.

FIG. 34B shows a side view of the piercing device 156 when the bag 104 is approaching the piercing device 156 when almost all beverage has been dispensed from the container (not shown). The beverage adjacent the piecing device 156 will flow out of the container and the bag will move adjacent the piercing device 156. Piercing of the bag 104 is still prevented by the flexible member 162.

FIG. 34C shows a side view of the piercing device 156 when even more beverage has been dispensed. The pressure difference between the inside of the bag 104 and the outside of the bag 104 will cause the bag to bend the flexible member 162 inwardly and cause the bag 104 to be pierced by the piercing member 160. The gas within the bag may when the dispensed through the dispensing device (not shown) in order to depressurize the beverage dispensing system.

As an alternative to the above piercing device, a bag having a predetermined breaking point may be used. Such bag will simply rupture when all beverage has been dispensed when a pressure difference is established between the inside and the outside of the bag.

The present pressurization system is preferably used together with a plastic beverage container such as a PET container, however, it is understood that the present pressurization system may also be used together with a metal container such a as a steel container or aluminium container.

Many modifications of the preferred embodiments of the invention disclosed herein will readily occur to those skilled in the art. Accordingly, the invention is intended to include all structures that fall within the scope of the appending claims.

List of parts

| | |
|---|---|
| 10. | Constant flow rate controller |
| 12. | Inlet |
| 14. | Outlet |
| 16. | Orifice |
| 18. | Flow control part |
| 20. | Flow control conduit |
| 22. | Rupturable membrane |
| 24. | Elastic flow control member |
| 26. | Rigid flow control member |
| 28. | Spring |
| 30. | Beverage dispensing system |
| 32. | Container |
| 34. | Inner space |
| 36. | Head space |
| 38. | Canister |
| 40. | Lid |
| 42. | Riser pipe |
| 44. | Dispensing device |
| 46. | Handle |
| 48. | Valve |
| 50. | Spout |
| 52. | Cover |
| 54. | Activation mechanism |
| 56. | Sealing |
| 58. | Capillary channel |
| 60. | Aperture |
| 62. | Bag |
| 64. | Gas connection |
| 66. | Beverage |
| 68. | Activated carbon |
| 70. | Wall |
| 72. | Groove |
| 74. | Holes |
| 76. | Curvature |
| 100. | Pressurization system |
| 102. | Canister |
| 104. | Bag |
| 106. | Lid |
| 108. | Gas inlet |
| 110. | Ribbon |
| 112. | Activated carbon |
| 114. | Weld |
| 116. | Channels |
| 118. | Upper edge |
| 120. | Lower edge |
| 122. | Side edge |
| 124. | Slit |
| 126. | Beverage dispensing system |
| 128. | Container |
| 130. | Dispensing device |
| 132. | Handle |
| 134. | Base |
| 136. | Mounting setup |
| 138. | Top part |
| 140. | Bottom part |
| 142. | Vacuum roller |
| 144. | Movable welders |
| 146. | Cap |
| 148. | Second setup |
| 150. | Non-driving roller |
| 152. | Driving roller |
| 154. | Welder |
| 156. | Piercing device |
| 158. | Beverage outlet |
| 160. | Piercing member |
| 162. | Flexible member |

1-30. (canceled)

31. A pressurization system for a beverage container defining a first diameter and having an internal volume, said pressurization system comprising:
a canister positioned within said internal volume, said canister including an adsorption material having an adsorbed specific amount of propellant gas sufficient for replacing said beverage included in said internal volume, said canister including a housing enclosing said adsorption material; and
a bag comprising an inner foil and an outer foil, said inner foil defining an inner upper edge, an opposite inner lower edge, a first side edge and an opposite second side edge welded to said first side edge, said inner foil defining an inner cylinder encircling said canister and defining a second diameter substantially equal to said first diameter, said outer foil defining an outer upper edge being welded to said inner upper edge forming a common upper edge, an outer lower edge welded to said inner lower edge forming a common lower edge, a third side edge and an opposite fourth side edge welded to said third side edge, said outer foil defining an outer cylinder encircling said inner cylinder, said bag defining an enclosed space between said inner cylinder and said outer cylinder, said bag having a gas inlet providing fluid communication between said canister and said enclosed space, said bag defining a non-activated state in which said bag is folded about said canister, and an activated state in which said bag is unfolded and filled by said propellant gas.

32. The pressurization system according to claim 1, wherein said enclosed space is separated into at least three internal spaces by joints extending partially between said common upper edge and said common lower edge.

33. The pressurization system according to claim 31, wherein said first and second side edges are welded to said third and fourth side edges.

34. The pressurization system according to claim 31, wherein said canister comprises a piercing device configured for ripping said bag when a pressure within said enclosed space increases above a pressure within said internal volume of said beverage container, said piercing device being covered by a flexible and pierceable protection plate.

35. The pressurization system according to claim 31, wherein said bag has a first cut out section and a second cut out section in the foils at opposite sides of said gas inlet for allowing additional flexibility of said bag adjacent said gas inlet.

36. The pressurization system according to claim 31, wherein said bag has a cut out section at said common lower edge.

37. The pressurization system according to claim 31, wherein said bag comprises a lower part including said common lower edge and an upper part including said common upper edge, said lower part being foldable towards said upper part.

38. The pressurization system according to claim 31, wherein said bag is made of a polymeric material.

39. The pressurization system according to claim 31, wherein said bag, when in said non activated state, is surrounded by a ribbon having a predetermined breaking point.

40. The pressurization system according to claim 39, wherein said ribbon is welded to said bag.

41. The pressurization system according to claim 39, wherein said ribbon completely encloses said bag.

42. A method of manufacturing a pressurization system for a beverage container, said beverage container defining a first diameter and having an internal volume, said method comprising the steps of:
providing a canister configured for being positioned within said internal volume, said canister including an adsorption material having an adsorbed specific amount of propellant gas sufficient for replacing a beverage in said internal volume, said canister including a housing enclosing said adsorption material;
providing an inner foil and an outer foil, said inner foil defining an inner upper edge, an opposite inner lower edge, a first side edge and an opposite second side edge, said outer foil defining an outer upper edge, an outer lower edge, a third side edge and an opposite fourth side edge;
welding said first side edge to said second side edge such that said inner foil defines an inner cylinder encircling said canister and defining a second diameter being substantially equal to said first diameter;
welding said third side edge to said fourth side edge such that said outer foil defines an outer cylinder encircling said inner cylinder;
welding said outer upper edge to said inner upper edge forming a common upper edge, and welding said outer lower edge to said inner lower edge forming a common lower edge, such that said inner cylinder and said outer cylinder thereby define a bag having an enclosed space between said inner cylinder and said outer cylinder;
separating said enclosed space into at least three internal spaces by joints extending partially between said common upper edge and said common lower edge;
establishing a gas inlet in said bag for providing fluid communication between said canister and said enclosed space; and
folding said bag about said canister.

43. The method according to claim 42, wherein said folding step is performed using the following sub-steps:
placing a mounting cylinder within said inner cylinder;
rotating said mounting cylinder while holding said bag onto said mounting cylinder by applying low pressure to said mounting cylinder, thereby folding said bag about said mounting cylinder; and
replacing said mounting cylinder with said canister.

44. The method according to claim 42, wherein said folding step is performed using the following sub-steps:
placing said canister within said inner cylinder;
surrounding said canister and said bag by mounting rollers pressing against said bag; and
rotating said mounting rollers and said canister while holding said mounting rollers pressed against said bag.

45. The method according to claim 42, further comprising the step of surrounding said bag by a ribbon having a predetermined breaking point.

46. A beverage dispensing system, comprising:
a beverage container defining an internal volume configured to contain a beverage;
an openable and closable dispensing device comprising a tapping line having a beverage inlet located within said internal volume in fluid communication with said internal volume and a beverage outlet located outside said beverage container;
a canister located within said internal volume and including an adsorption material having an adsorbed specific amount of propellant gas sufficient for replacing a beverage in said internal volume, said canister including a housing enclosing said adsorption material; and
a bag in fluid communication with said canister and located within said internal volume, said bag defining a first state in which said bag is folded and occupies less than 10% of said internal volume, and a second state in which said bag is unfolded and occupies at least 70% of said internal volume.

47. The beverage dispensing system according to 46, wherein said bag is made of a material selected from the group consisting of one or more of metal, metal coated polymeric material, and polymeric material having a gas barrier.

48. The beverage dispensing system according to claim 46, wherein said canister at least partially encloses said tapping line.

49. The beverage dispensing system according to claim 46, wherein said housing of said canister comprises one or more grooves extending from a bottom surface of said housing to a top surface of said housing for allowing beverage to flow within said one or more grooves between said bottom surface and said top surface.

50. The beverage dispensing system according to claim 49, wherein said one or more grooves are linear.

51. The beverage dispensing system according to claim 49, wherein said one or more grooves are helical.

52. The beverage dispensing system according to claim 46, wherein said bag is fastened onto said beverage container.

53. The beverage dispensing system according to claim 46, wherein said internal volume contains a plurality of canisters and a plurality of bags.

54. The beverage dispensing system according to claim 53, wherein, when said bags are in said first state, said canisters are positioned at a central axis defined said container, and when said bags are in said second state, said canisters are located at a distance from said central axis.

55. The beverage dispensing system according to claim 54, wherein said container defines a cylindrical shape, wherein said central axis defines a first length, and wherein each of said canisters defines a second length exceeding said first length.

56. The beverage dispensing system according to claim 46, wherein said canister defines a cylindrical surface and said bag is connected to said cylindrical surface, so that, when in said first state, said bag is rolled around said cylindrical surface.

57. A beverage dispensing system, comprising:
a beverage container defining an internal volume;
a bag located within said internal volume, said bag including a beverage and a canister, said canister including an adsorption material having adsorbed a specific amount of propellant gas sufficient for replacing said beverage included within said bag, said canister being in fluid communication with said internal volume outside said bag, said canister including a housing enclosing said adsorption material for preventing contact between said adsorption material and said beverage, said bag defining a first state in which said bag is unfolded and occupies at least 70% of said internal volume while said beverage contacts at least 25% of said housing of said canister, and a second state in which said bag is folded and occupies less than 10% of said internal volume while said beverage contacts at least 25% of said housing of said canister; and
an openable and closable dispensing device comprising a tapping line having a beverage inlet located within said bag in fluid communication with said beverage and a beverage outlet located outside said beverage container.

58. The beverage dispensing system according to claim 57, wherein said housing extends from said dispensing device.

59. The beverage dispensing system according to claim 57, wherein said beverage is a carbonated beverage defining an equilibrium pressure, and wherein said canister defines an internal gas pressure corresponding to said equilibrium pressure.

60. The beverage dispensing system according to claim 57, wherein said beverage is a carbonated beverage defining an equilibrium pressure, and wherein said canister defines an internal gas pressure exceeding said equilibrium pressure.

61. A method of dispensing a beverage, comprising:
(a) being provided with a beverage dispensing system comprising:
(i) a beverage container defining an internal volume containing a beverage;
(ii) an openable and closable dispensing device comprising a tapping line having a beverage inlet located within said internal volume in fluid communication with said beverage and a beverage outlet located outside said beverage container;
(iii) a canister located within said internal volume, said canister including an adsorption material having adsorbed a specific amount of propellant gas sufficient for replacing said beverage contained in said internal volume, said canister including a housing enclosing said adsorption material; and
(iv) a bag in fluid communication with said canister and located within said internal volume, said bag being folded and occupying less than 10% of said internal volume while said beverage contacts at least 25% of said housing; and
(b) opening said dispensing device, thereby causing said beverage to flow from said beverage inlet to said beverage outlet and said bag to receive propellant gas from said adsorption material while said bag is unfolding and said beverage contacts at least 25% of said housing until said bag occupies at least 70% of said internal volume.

62. A method of dispensing a beverage, comprising:
(a) being provided with a beverage dispensing system, comprising:
(i) a beverage container defining an internal volume;
(ii) a bag located within said internal volume, said bag containing a beverage and a canister, said canister including an adsorption material having adsorbed a specific amount of propellant gas sufficient for replacing said beverage included within said bag, said canister being in fluid communication with said internal volume outside said bag, said canister including a housing enclosing said adsorption material, said bag occupying at least 70% of said internal volume while said beverage contacts at least 25% of said housing; and
(iii) an openable and closable dispensing device comprising a tapping line having a beverage inlet located within said bag in fluid communication with said beverage and a beverage outlet located outside said beverage container; and
(b) opening said dispensing device, thereby causing said beverage to flow from said beverage inlet to said beverage outlet and said internal volume outside said bag to receive propellant gas from said adsorption material while said bag is being folded, and said beverage contacts at least 25% of said housing until said bag occupies less than 10% of said internal volume.
